(19) United States
(12) Patent Application Publication
(10) Pub. No.: US 2016/0200153 A1
(43) Pub. Date: Jul. 14, 2016

(54) TIRE WELLNESS SYSTEM

(71) Applicant: MOBILE AWARENESS, LLC, Solon, OH (US)

(72) Inventor: Gary Steven Rothstein, Orange Village, OH (US)

(73) Assignee: Mobile Awareness, LLC, Solon, OH (US)

(21) Appl. No.: 14/913,092

(22) PCT Filed: Jul. 10, 2014
(86) PCT No.: PCT/US2014/046250

§ 371 Date: Feb. 19, 2016

Related U.S. Application Data
(60) Provisional application No. 61/867,852, filed on Aug. 20, 2013.
(60) Provisional application No. 61/916,730, filed on Dec. 16, 2013.

(51) Int. Cl. B60C 23/04; B62D 53/00; G07C 5/00; G07C 5/08; B60C 23/00; B60C 23/20

(52) U.S. Cl. CPC B60C 23/0415; B60C 23/008; B60C 23/009; B60C 23/0479; B60C 23/0486; B60C 23/20; G07C 5/008; G07C 5/085; G07C 5/0816; G07C 5/0825; B62D 53/00

(57) ABSTRACT

A truck comprises a tractor and a trailer hitched thereto. At least one tire is mounted on each end of each of the tractor's axles and at least one tire is mounted on each end of each of the trailer's axles. A sensor is associated with each tire. Each sensor acquires tire-condition data about its respective tire and transmits this tire-condition data to a proctor. The proctor can coordinate realtime tire-condition displays, facilitate flagging of tire-condition problem tires in a fleet yard, and/or allows large data downloads for historical evaluation.

### RELATED APPLICATION

This application is related to U.S. Provisional Patent Application No. 61/867,852 filed on Aug. 20, 2013 and U.S. Provisional Patent Application No. 61/916,730 filed on Dec. 16, 2013. The entire disclosures of these earlier applications are hereby incorporated by reference. To the extent that any inconsistencies exist between the present application and an earlier incorporated application, the present application governs for the purposes of resolving definiteness and/or clarity issues. For the purposes of the United States, this application claims priority under 35 USC §119(e).

### BACKGROUND

Trucks are responsible for the majority of freight movement over land and they are vital links in supply chains of the manufacturing, transportation, and warehousing industries. In a common scenario, a plurality of tractors are interchangeably hitched to a plurality of tractors and/or driven by a plurality of drivers. Truck tires are continuously swapping axle spots on the same vehicle, frequently being switched from one vehicle to another, and/or being cycled through inventory. For these and other reasons, any attempt to implement a comprehensive tire wellness system can quickly turn into a logistic nightmare.

### SUMMARY

A comprehensive tire wellness system is provided for which can be easily integrated into existing fleets and/or yards, which eliminates tractor-trailer-interchange tracking issues, which does not depend upon driver diligence for implementation, and/or which can support historical evaluation on an asset-by-asset basis. Furthermore, the system allows a tire manufacturer to track its tires in the field to determine whether low performance stems from factory-originating defects or from poor tire care practices.

### DRAWINGS

FIGS. 1A-1C show trucks 100, tractors 200, trailers 300, tires 400, sensors 500, proctors 600, display destinations 700, download destinations 800, and fleets 900;

FIGS. 2A-2I show trucks 100, tractors 200, trailers 300, tires 400, sensors 500, proctors 600, display destinations 700, download destinations 800, and fleets 900;

FIGS. 3A-3Y show trucks 100, tractors 200, trailers 300, tires 400, sensors 500, proctors 600, display destinations 700, download destinations 800, and fleets 900;

FIGS. 4A-4E show trucks 100, tractors 200, trailers 300, tires 400, sensors 500, proctors 600, display destinations 700, download destinations 800, and fleets 900;

FIGS. 5A-5B show trucks 100, tractors 200, trailers 300, tires 400, sensors 500, proctors 600, display destinations 700, download destinations 800, and fleets 900;

FIGS. 6A-6U show trucks 100, tractors 200, trailers 300, tires 400, sensors 500, proctors 600, display destinations 700, download destinations 800, and fleets 900;

FIGS. 7A-7L show trucks 100, tractors 200, trailers 300, tires 400, sensors 500, proctors 600, display destinations 700, download destinations 800, and fleets 900;

FIGS. 8A-8C show trucks 100, tractors 200, trailers 300, tires 400, sensors 500, proctors 600, display destinations 700, download destinations 800, and fleets 900; and

FIGS. 9A-9E show trucks 100, tractors 200, trailers 300, tires 400, sensors 500, proctors 600, display destinations 700, download destinations 800, and fleets 900.

### DESCRIPTION

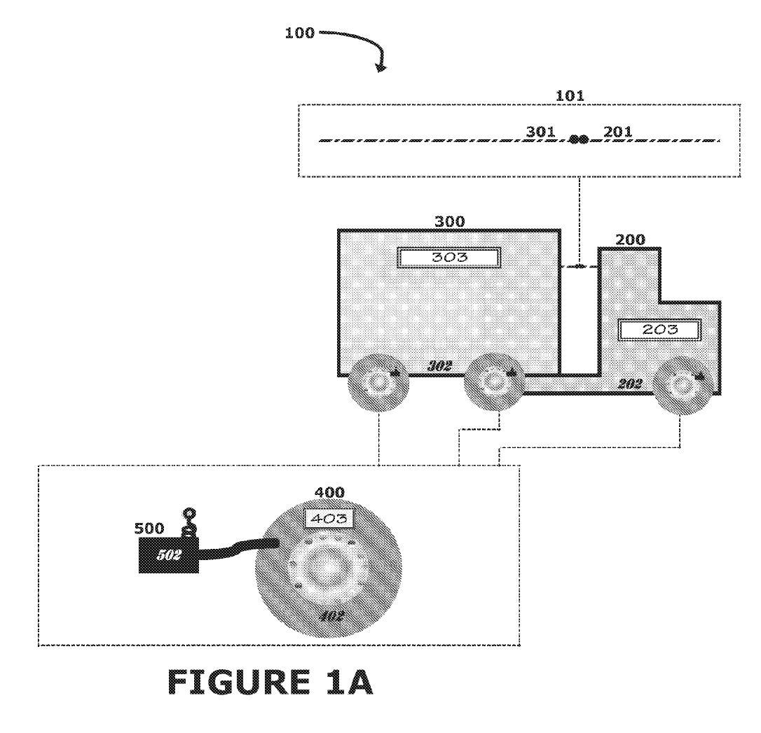

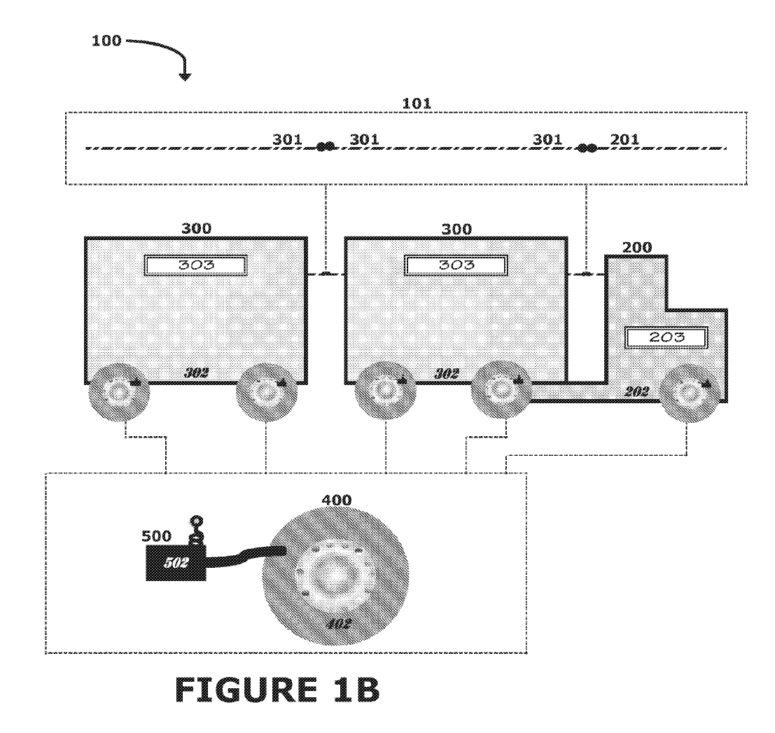

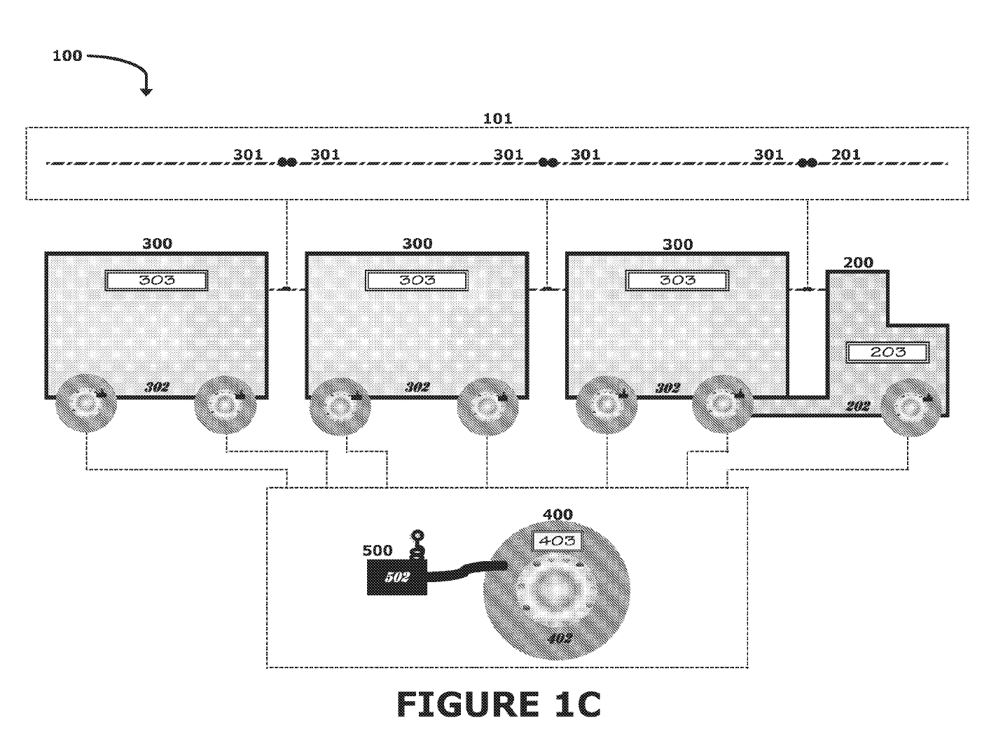

A truck 100 can comprise a tractor 200 and one or more trailers 300 hitched thereto. (FIGS. 1A-1C.) Specifically, for example, one trailer 300 can be hitched to the tractor 200, two trailers 300 can be hitched to the tractor 200, or three trailers 300 can be hitched to the tractor 200. Thus a truck 100 can consist of two vehicles, three vehicles, or four vehicles.

In addition to being mechanically hitched together, the tractor 200 and the trailer(s) 300 are electrically connected via a truck power line 101. This power line 101 is used to supply electrical energy to truck equipment (e.g., brake lights, head lights, blinkers, etc.). It can also be used to convey information (e.g., data signals) from one vehicle to another. The truck power line 101 is formed by the electrical connection of the tractor power line 201 and the trailer power line(s) 301.

Each tractor 200 can be allocated a unique identifier 202 and each trailer 300 can be allocated a unique identifier 302. Each tractor 200 will usually also possess an owner identifier 203 and each trailer 300 will usually also possess an owner identifier 303. If a fleet owns a plurality of tractors 200, they will all have the same owner identifier 203 (e.g., USDOT number) but different vehicle identifiers 201. Likewise, if a fleet owns a plurality of trailers 300, they will all have the same owner identifier 303 (e.g., USDOT number), but different vehicle identifiers 302. A unique vehicle identifier 202/302 which is an amalgamation of an owner identifier 203/303 and a distinctive idiom would be appropriate and may be advisable.

The vehicles' tires 400 can also each be allocated a unique identifier 402 which identifies it and only it. A tire 400 will usually also include a production identifier 403 (e.g., USDOT number) which identifies its manufacturing details. Thus, when a tire manufacturer produces a batch of hundred tires 400, each tire 400 in this batch will have the same production identifier 403 but a distinct tire identifier 402. A unique tire identifier 402 which is formulated by combining its production identifier 403 with an exclusive term would be credible and may be convenient.

A sensor 500 is associated with each tire 400 so as to acquire tire-condition information thereabout. Each sensor 501 can be assigned a unique sensor identifier 502 (e.g., a serial number) which corresponds to it and only to it. This unique identifier 502 can be assigned early in the sensor's life, such as by the manufacturer early in assembly steps. However, a unique sensor identifier 502 which is assigned upstream in the supply chain is workable and may be worthwhile.

### Tractors 200

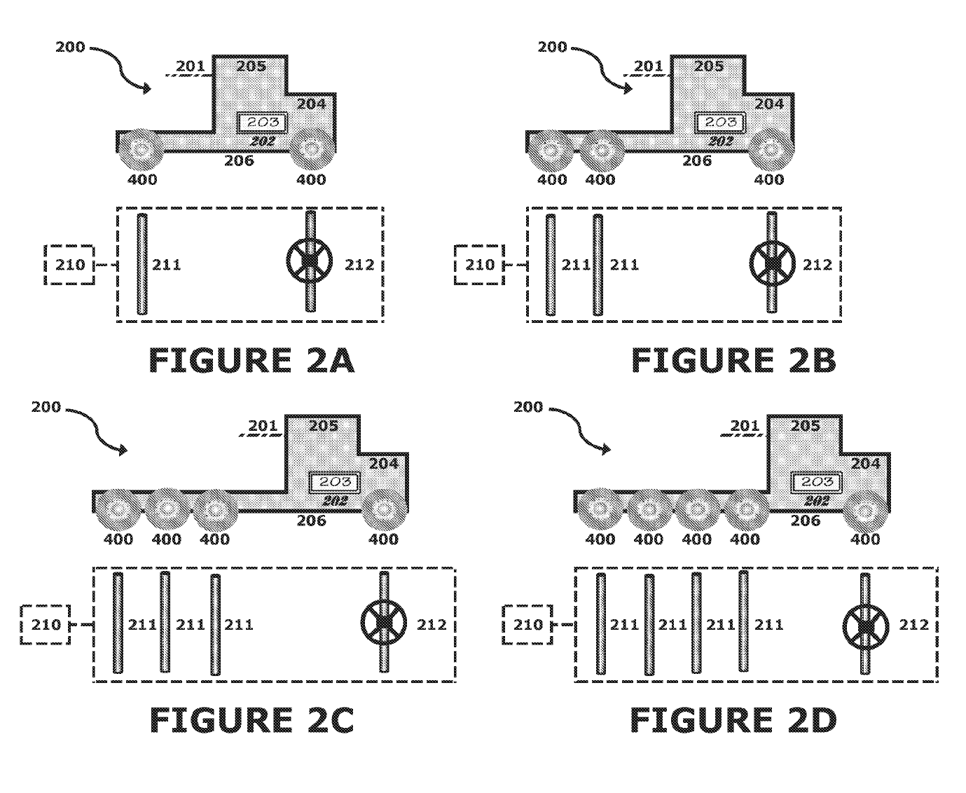

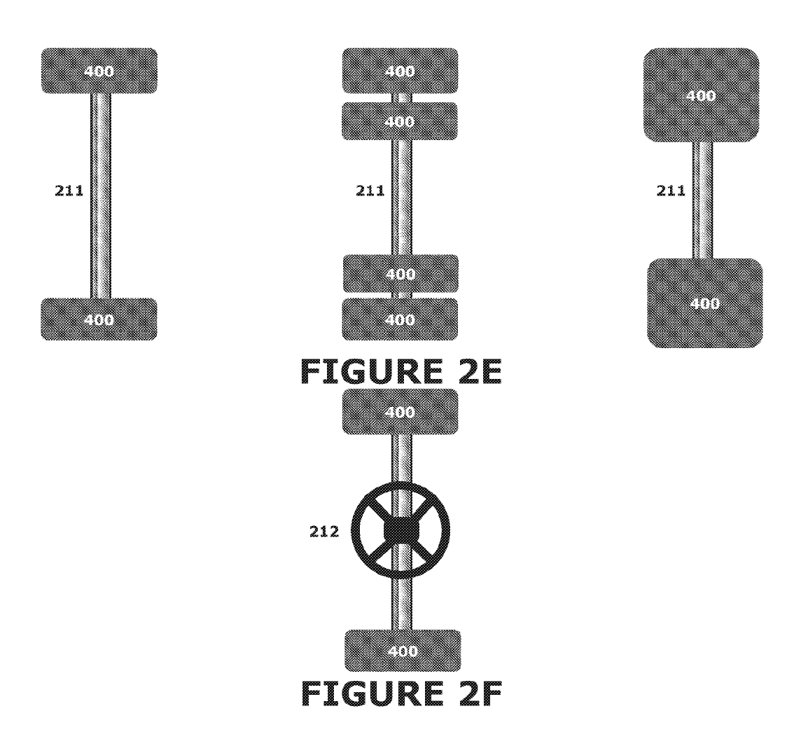

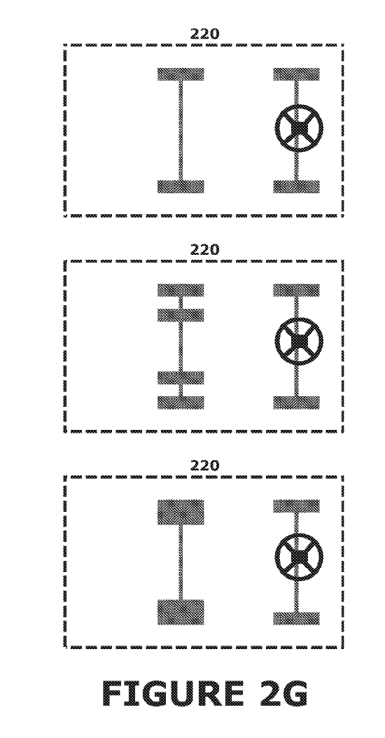

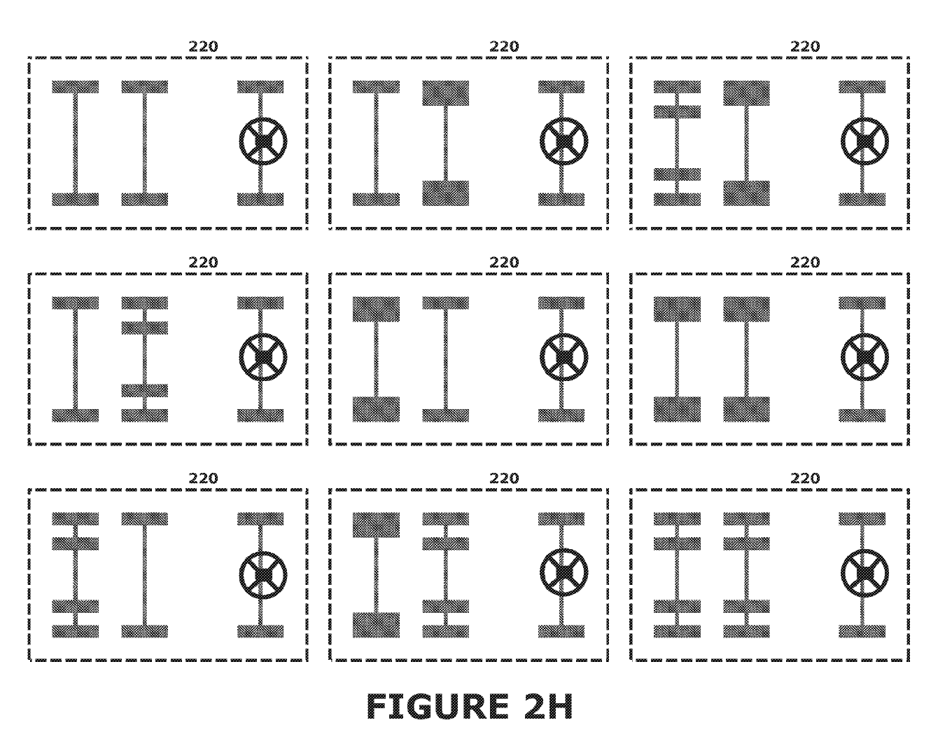

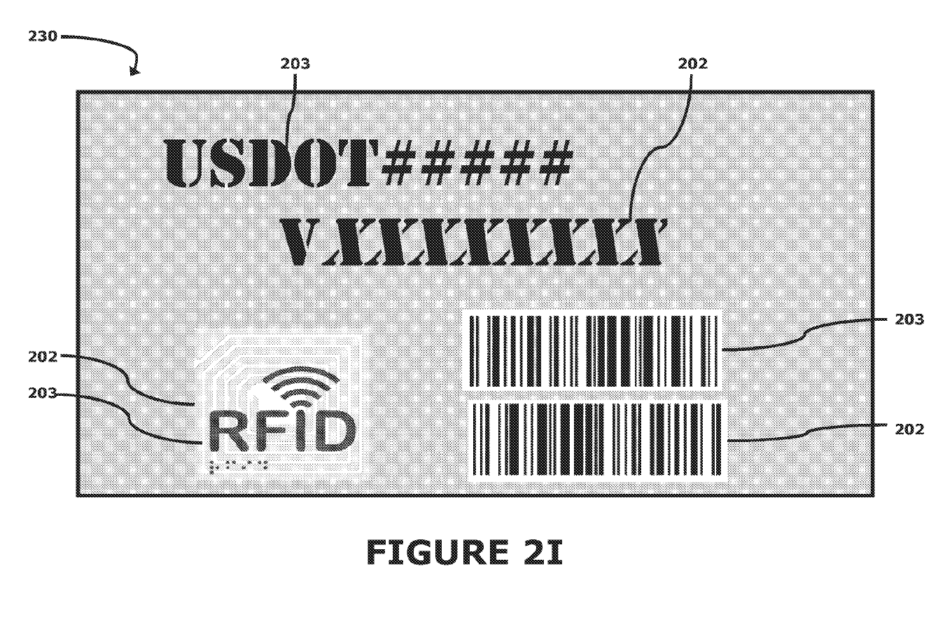

### (FIGS. 2A-2l)

A tractor 200 can comprise an engine 204, a driver cab 205, and a bed 206 to which a tractor 300 can be hitched. (FIGS. 2A-2D.) The tractor's engine 204 (and/or an associated battery) provides the power source for the truck 100 and the tractor power line 201 is electrically connected to this power source.

A tractor 200 will have an axle arrangement 210 comprising one or more rear axles 211 and a front steering axle 212. For example, a tractor 200 can have one rear axle 211, two rear axles 211, three rear axles 211, or four rear axles 211. While it is physically possible to modify a tractor's axle arrangement 210, such a modification would be the exception rather than the rule. In most cases, a tractor's assembly-line axle arrangement 210 is still there years later when the tractor 200 is retired.

At least one tire 400 is mounted on each end of each rear axle 211. More specifically, a single tire 400 can be mounted on each end of the axle 211, a pair of tires 400 can be mounted on each end of the axle 211, or a double-wide tire 400 can be mounted on each end of the axle 211. (FIG. 2E.) Typically, a single tire 400 is mounted on each end of the tractor's steering axle 212. (FIG. 2F).

A tractor 200 will have a tire-axle configuration 220 corresponding to its axle arrangement 210 and the tire-mounting thereon. Unlike axle arrangements 210, a tractor's tire-axle configuration 220 can change over time depending on the tires 400 mounted on its rear axles 211.

For example, the tractor 200 shown in FIG. 2A could have any one of the three tire-axle configurations 220 shown in FIG. 2G and the tractor 200 shown in FIG. 2B could have any one of the nine tire-axle configurations 220 shown in FIG. 2H. Similarly, the tractor 200 shown in FIG. 2C could have twenty-seven possible tire-axle configurations and the tractor 200 shown in FIG. 2D could have eighty-one possible tire-axle configurations.

Each tractor 200 can be provided with a tag 230 which contains its unique vehicle identifier 201. (FIG. 21.) The tag 230 can also contain the tractor's owner identifier 203 and/or other information. The vehicle identifier 202 is preferably contained with the tag 230 in a readable format (e.g., alphanumeric print), in a scannable format {e.g., barcode) and/or in a wirelessly obtainable format (e.g., RFID chip). These formats may be integrated onto the same physical tag 230 or they can have separate dwellings.

### Trailers 300

### (FIGS. 2A-2l)

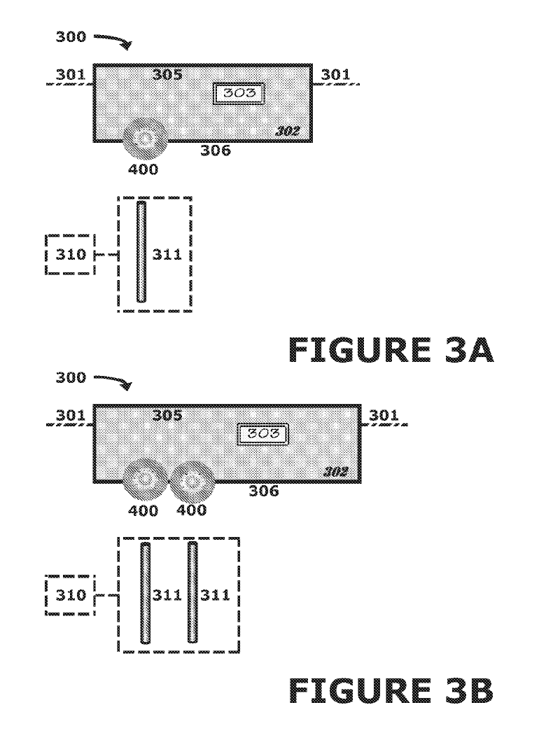

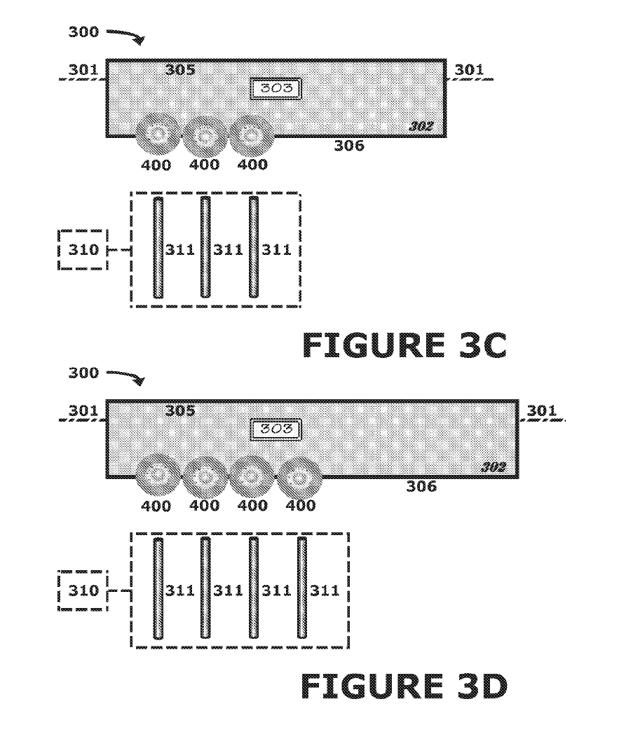

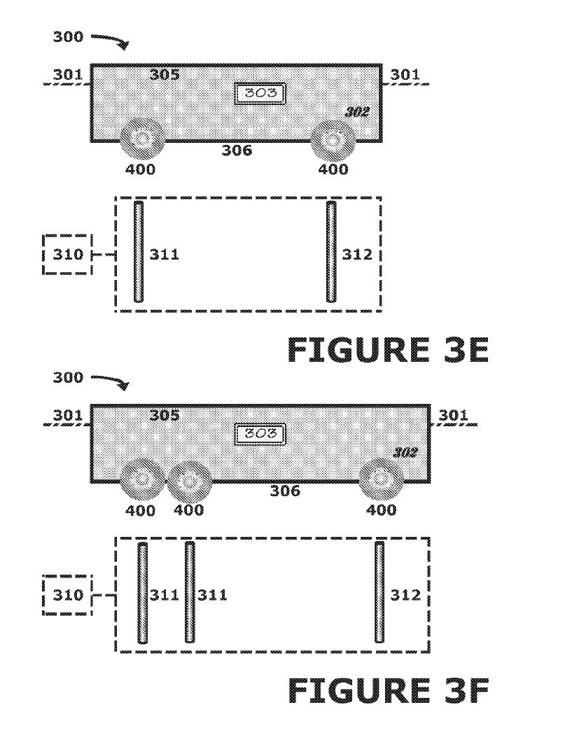

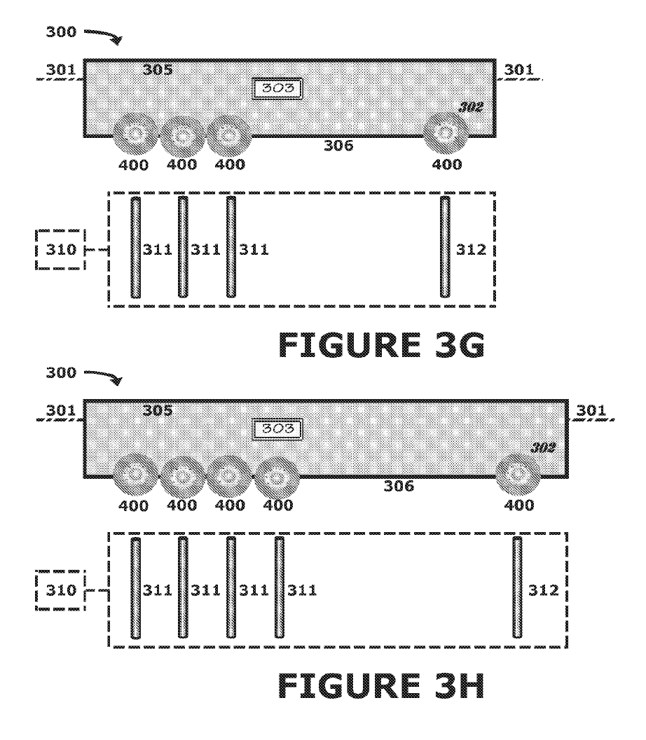

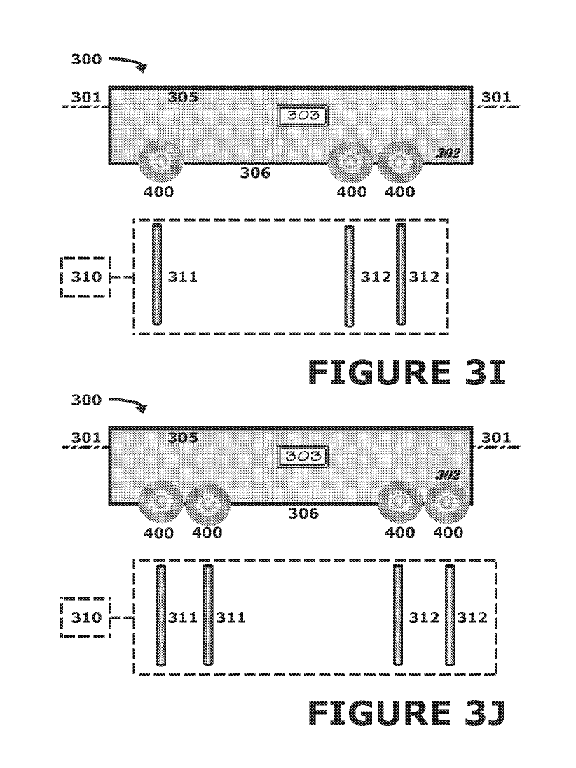

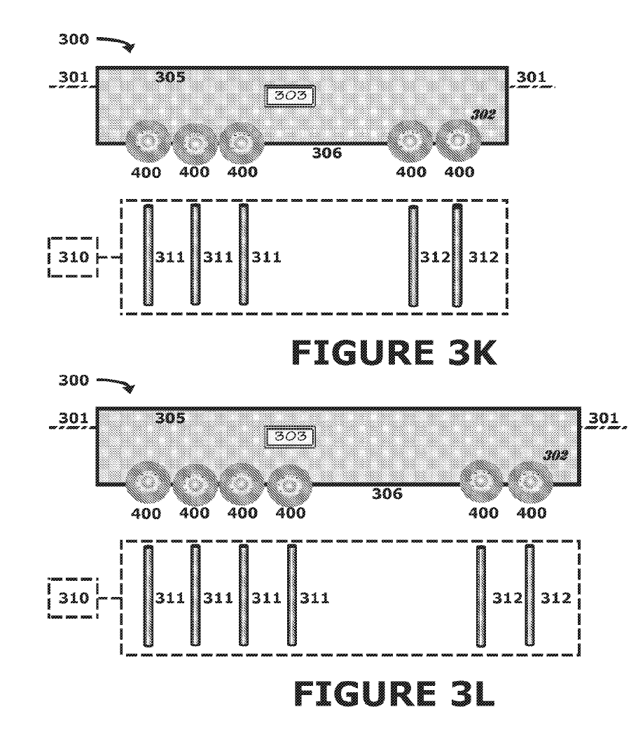

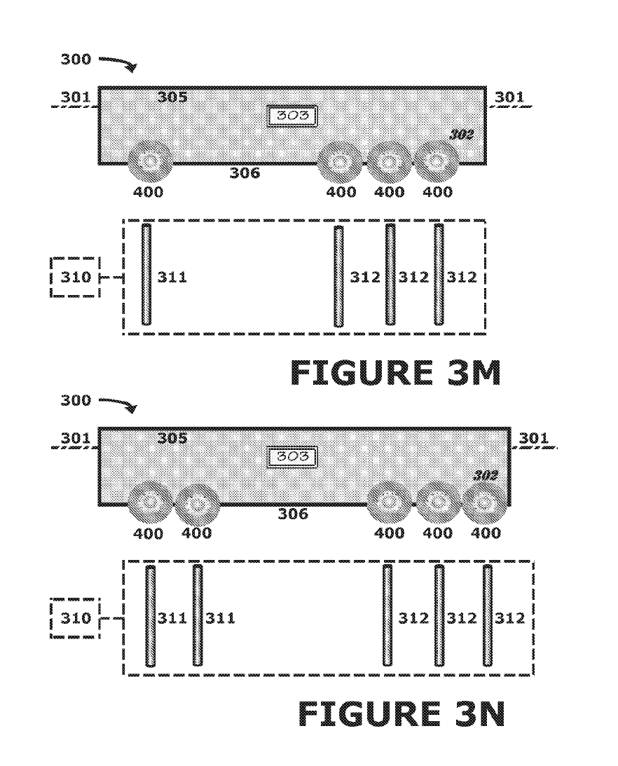

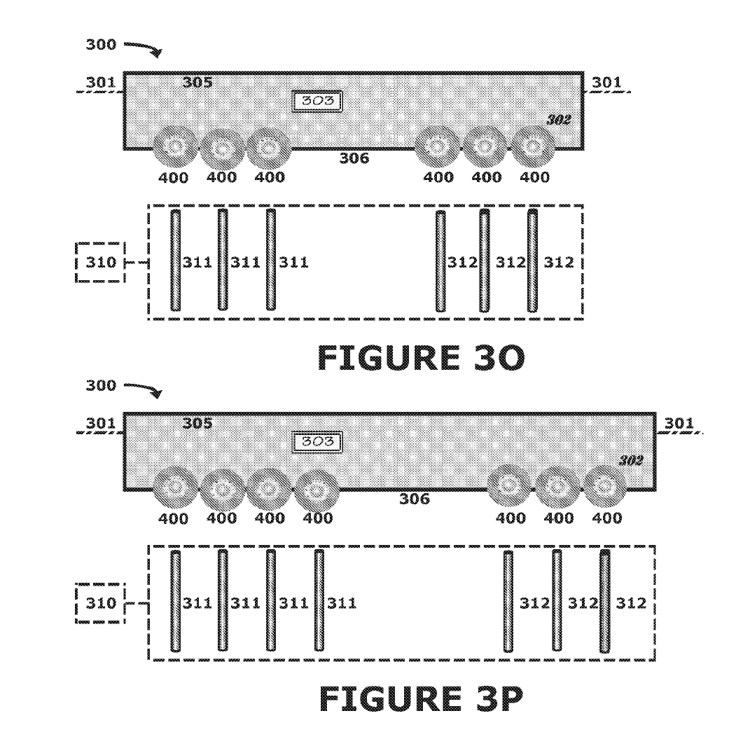

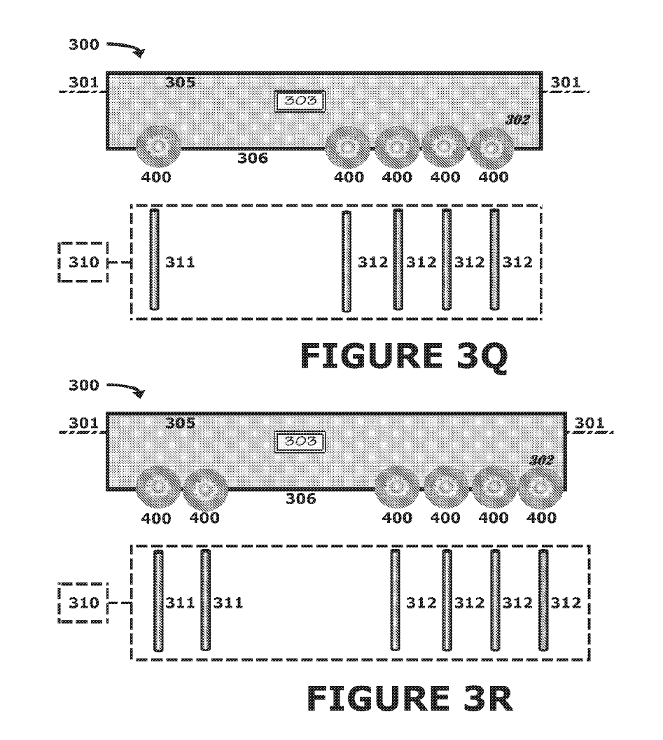

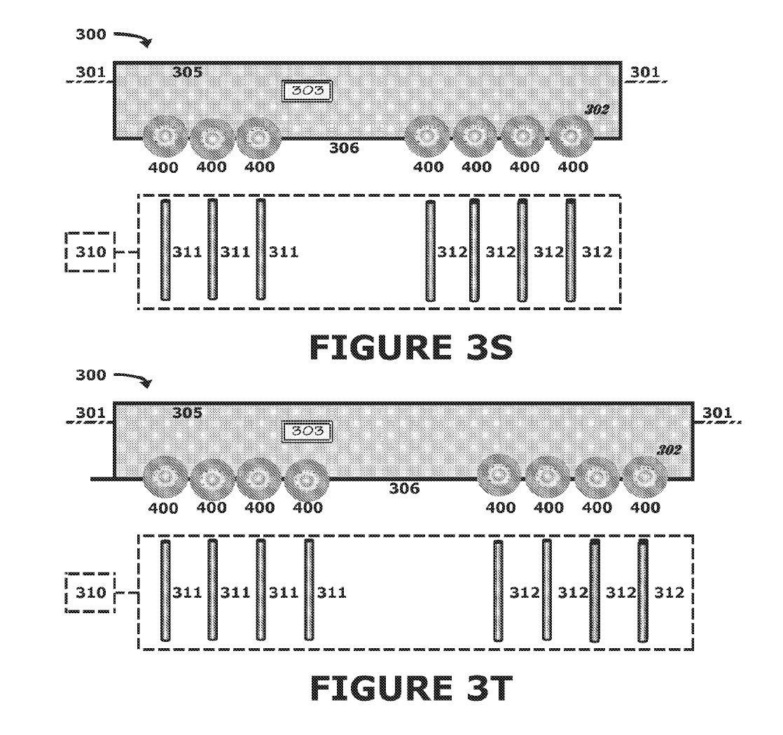

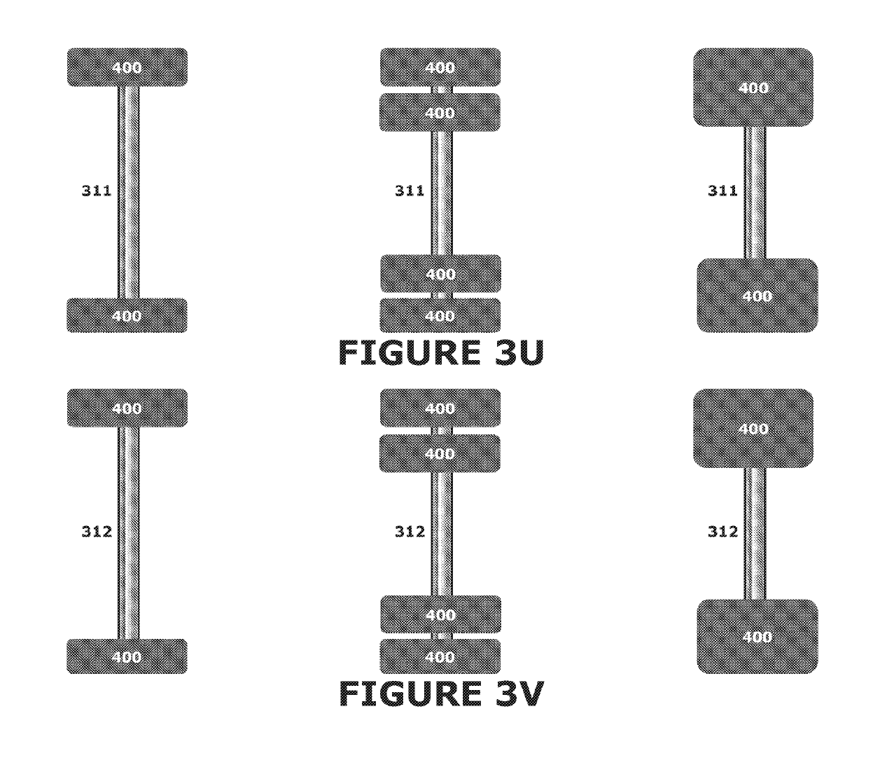

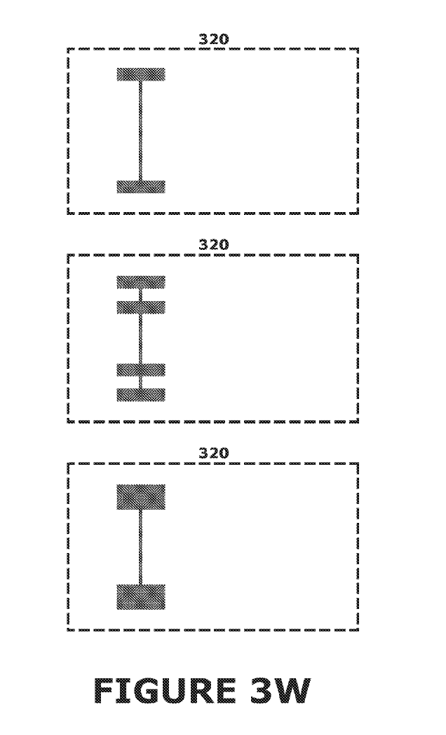

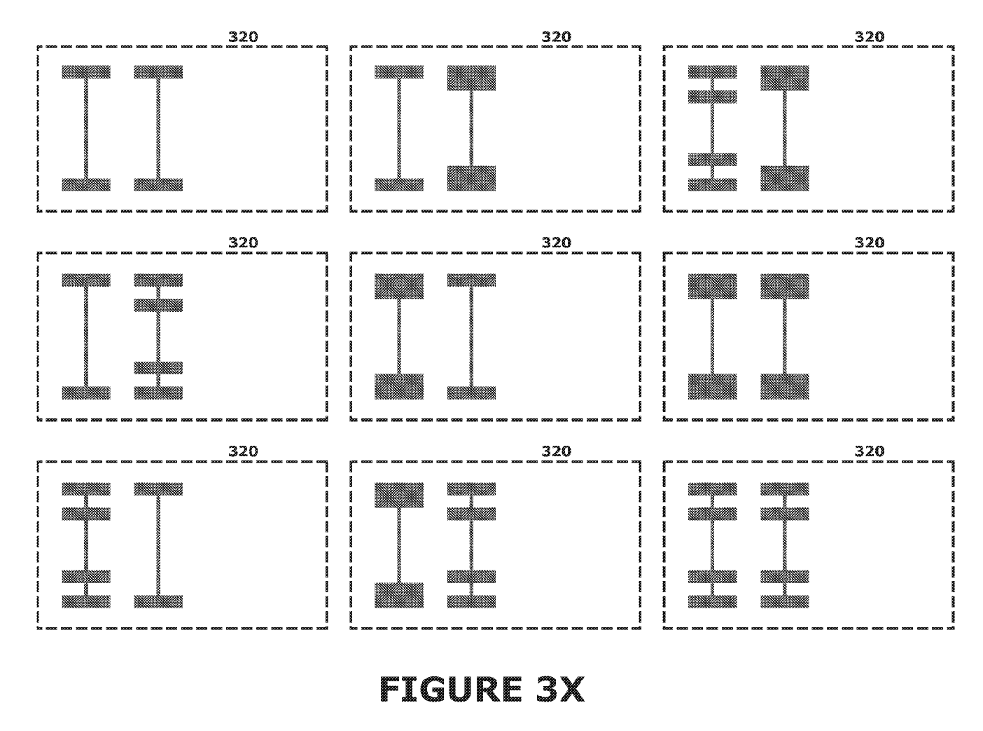

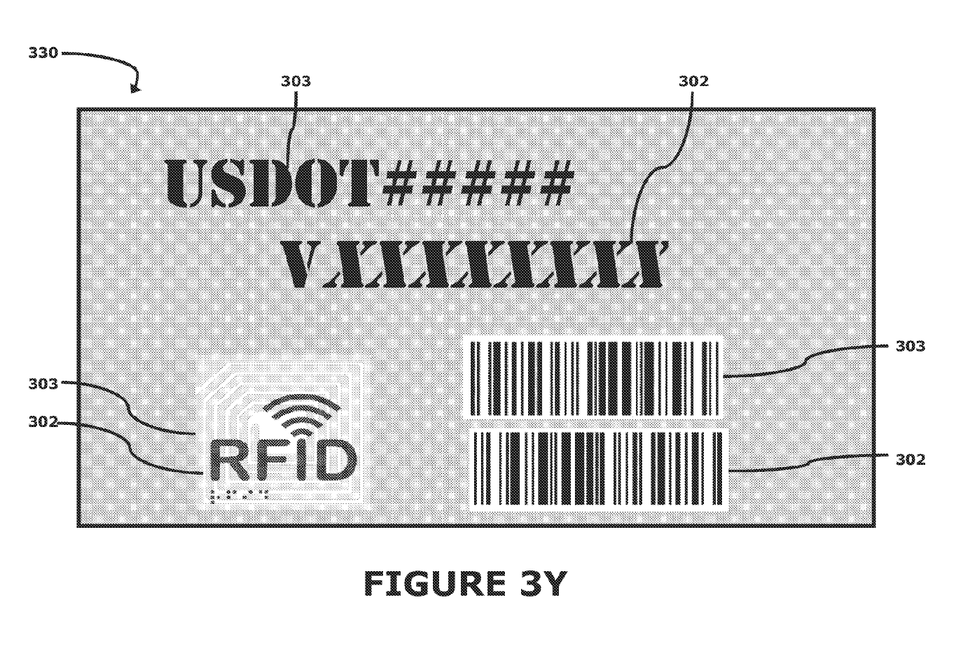

A trailer 300 can comprise cargo space 305 and a bed 306 for supporting the cargo space 305. (FIG. 3A-3T.) A trailer's axle arrangement 310 can comprise from one to eight axles 311-312. More specifically, a trailer 300 can have one rear axle 311, two rear axles 311, three rear axles 311, or four rear axles 311. And a trailer 300 can have no front axle, one front axle 312, two front axles 312, three front axles 312, and/or four front axles 312. As with tractor axle arrangements 210, trailer axle arrangements 310 are usually not modified over the course of the vehicle's life.

A single tire 400 can be mounted on each end of a tractor axle 311-312, a pair of tires 400 can be mounted on each end of a tractor axle 311-312, or a double-wide tire 400 can be mounted on each end of a tractor axle 311-312. (FIGS. 3U-3V.) A trailer 300 will have a tire-axle configuration 320 corresponding to this tire mounting on its axles 311-312.

As with tractors 200, a trailer's tire-axle configuration 320 can change frequently. For example, the trailer 300 shown in FIG. 3A could have any one of the three tire-axle configurations 320 shown in FIG. 3W and the trailer 300 shown in FIG. 3B could have any one of the nine axle configurations 320 shown in FIG. 3W. The trailers 300 shown in FIGS. 3C-3T could likewise have a multitude of possible tire-axle configurations 320. (i.e., three raised to the trailer axle-number power).

Each trailer 300 can be provided with a tag 330 which contains its unique vehicle identifier 302. (FIG. 3Y.) The trailer tag 330, like the tractor tag 230, can also contain an owner identifier 303 and/or other trailer information. It can be formatted to be human-readable, scannable, and/or wirelessly obtainable, with these formats being presented in one or more tag types.

### Tires 400

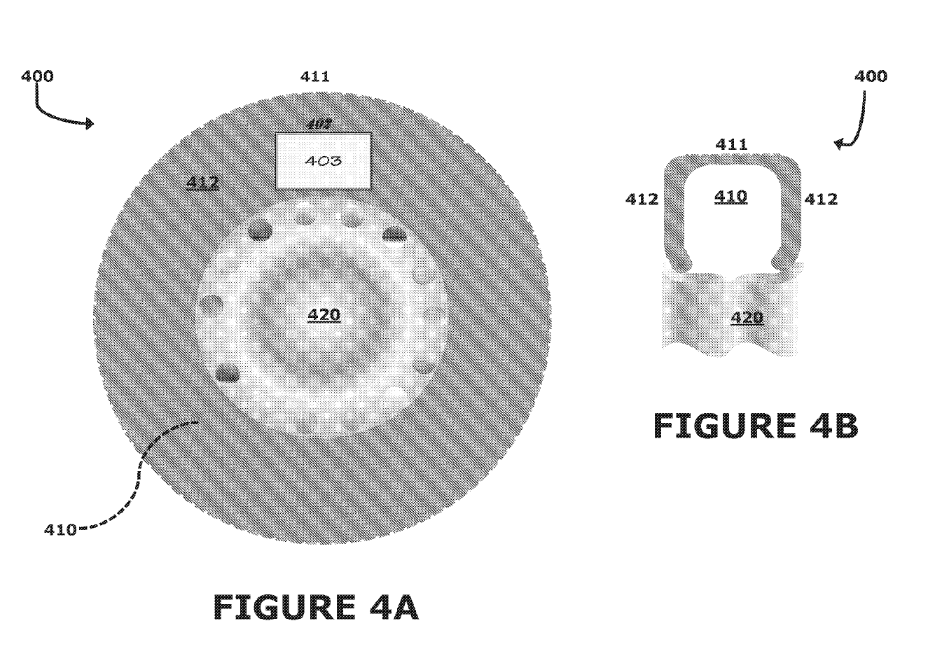

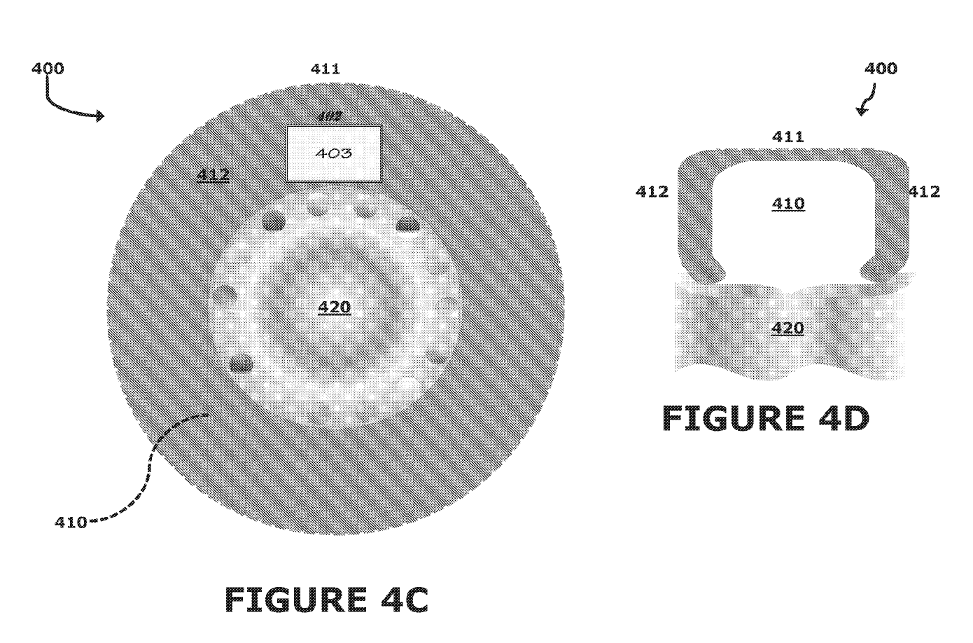

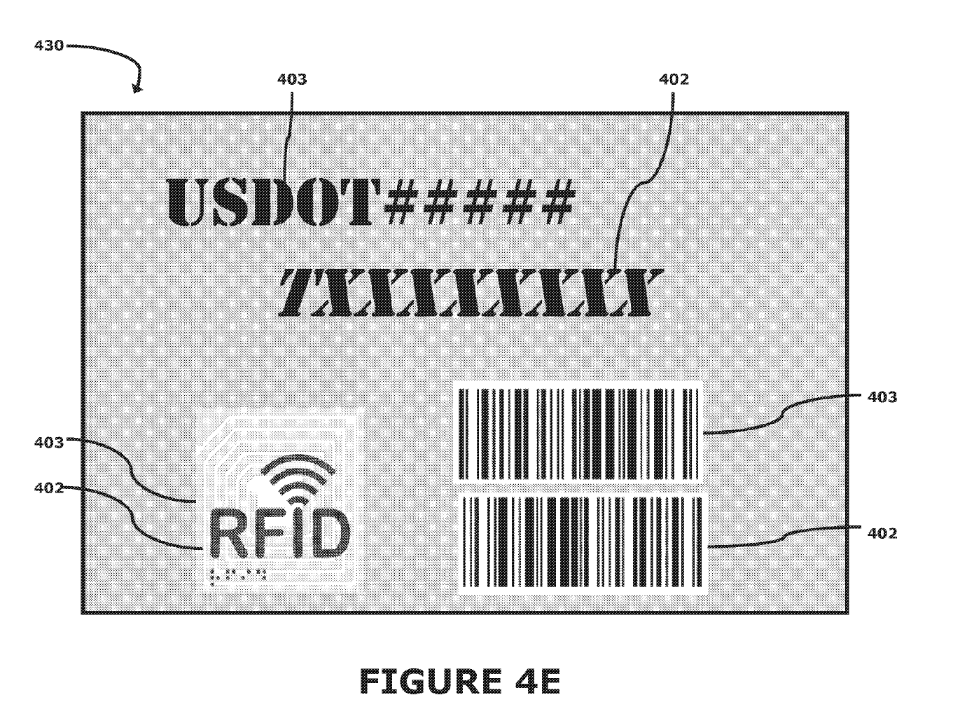

### (FIGS. 4A-4E)

Each tire 400 has an air chamber 410 which is inflated to achieve an appropriate tire pressure. The air chamber 410 is formed by a tread 411, sidewalls 412, and a rim 420. A tire 400 can have a standard width (FIGS. 4A-4B) or a double width (FIGS. 4C-4D). Other tire widths are creatable and could be incorporated into a tire wellness system.

Each tire 400 can be provided with a tag 430 which contains its unique tire identifier 402 and which may contain other information, such as its production identifier 403. (FIG. 4E.) If this tag 430 is provided by the tire manufacturer, it can be embedded into the carcass of the tire 400 during assembly. If the tag 430 is provided downstream of the tire manufacturer, it can be situated within the air chamber 410 or attached to a sidewall 412.

In either or any case, the information on the tire tag 430 can be readable by a human (e.g., alphanumeric print on a sidewall 412), optically scannable (e.g., barcode on a sidewall 412), and/or wirelessly obtainable (e.g., an RFID chip on or in the tire 400). All or some of these formats may be provided at the same site on the tire. And/or multiple labels and/or chips could collectively form the tire tag 430.

The unique tire identifier 402 allows a tire manufacturer to track its tires 400 in the field and collect data therefrom. This data can be used to determine whether poor tire performance stems from factory-originating defects or field-imposed injuries. For example, the tire manufacturer can evaluate whether a particular tire 400 was driven at proper pressures and/or temperatures. Moreover, it a tire manufacturer takes on the service of tires 400 to preserve their quality, it can correlate realtime readings to a particular tire to optimize inspection and maintenance.

### Sensors 500

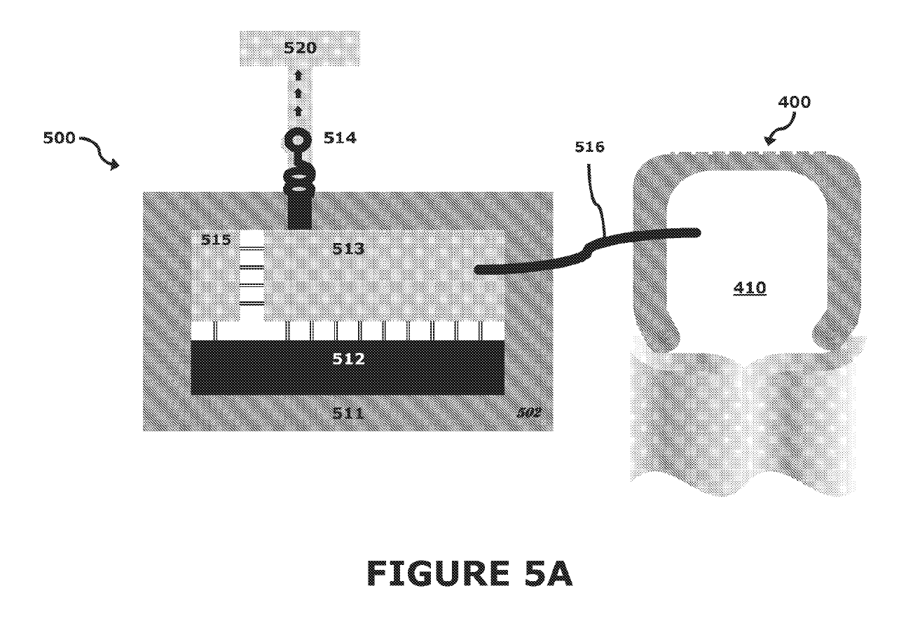

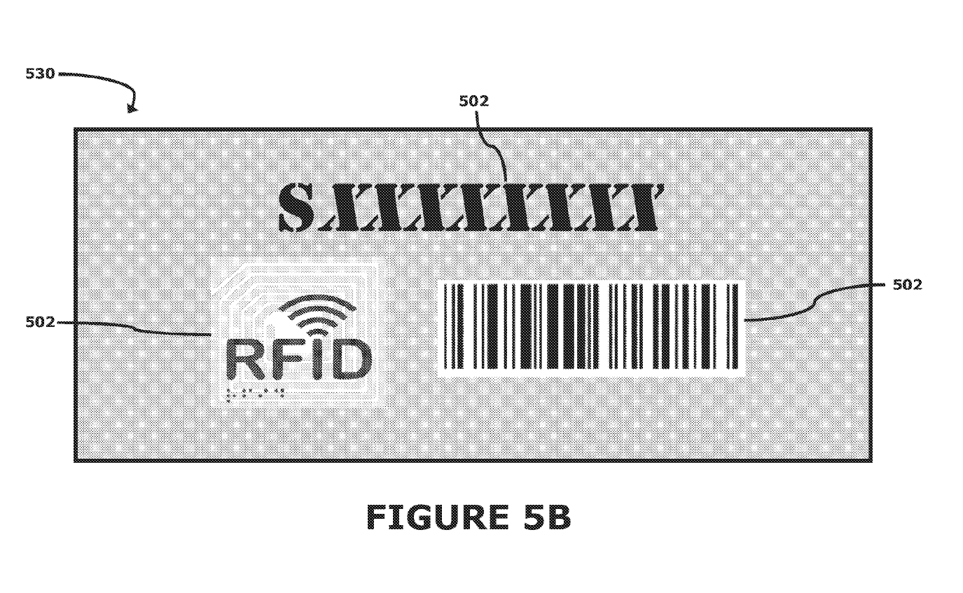

### (FIGS. 5A-5B)

Each sensor 500 can comprise a housing 511, a power source 512, a processor 513, an antenna 514, and a memory 515. The housing 511 encloses at least some of the other sensor components (e.g., the power source 512 and the processor 513). The housing 511 can generally define the sensor's dimensions, which are preferably relatively small (e.g., less than twenty centimeters, less than fifteen centimeters, and/or less than ten centimeters). But larger sensor housings 511 are doable and may be desirable.

The sensor's power source 512 supplies power to the processor 513 and the antenna 514. It can comprise a battery enclosed within the housing 511, this battery having a long excepted life (e.g., at least two years, at least four years, at least six years, and/or at least eight years). In many cases, the battery may dictate the duration of a sensor's duty. However, a limited-life battery, a rechargeable battery, and/or a replaceable battery are obtainable and may be options.

A sensor 500 having a power source 512 which is additionally or alternatively achieved through wired or wireless lines to an external power supply (e.g., through the vehicle power lines 201-301) is buildable and may be beneficial. But a self-sufficient construction, which does not rely on any outside equipment for operation, may best fit pre-release testing by the sensor manufacturer.

The processor 513 is programmed to collect tire-condition data via a path 515 which is in fluid communication with the air chamber 410 of a tire 400. This data will include air pressure within the chamber 410 and may include other parameters such as temperature.

Fluid communication can be accomplished by physically positioning the sensor 500 within the tire's air chamber 410. Alternatively, the sensor 500 can be secured to a passage (e.g., a valve stem) leading into the tire's air chamber 410. Another option is to plumb a path between the air chamber 410 so that the sensor 500 so that it can be mounted elsewhere (e.g., on the tire's rim 420).

The processor 513 can also be programmed to transmit tire-condition condition data through the antenna 514. This data transmission can occur at a relatively rapid pace (e.g., at least once every three hundred seconds, at least once every two hundred seconds, and/or at least once every one-hundred seconds). However, slower transmissions may be adequate and acceptable in some tire wellness programs.

The tire-condition data can be transmitted in data packets 520. Each packet 520 can include packet statistical data (e.g., packet length, packet sequence, etc.), sensor-identification data (e.g., the sensor's unique identifier 502), tire-condition data (e.g., pressure and/or temperature), and other relevant data. The sensor-identification data is necessary to trace tire-condition data back to its instigating tire 400. Data packet transmissions, and even non-packet transmissions, which can accomplish such sensor-tire mapping in another manner would be permissible and could be prudent.

The memory 515 can be used to temporarily store data during brief transmission lags. In most tire wellness programs, a sensor's primary purpose will be to quickly transmit tire-condition data, whereby memory magnitude need not be impressive. That being said, a sensor memory adapted to store data for extended time periods is achievable and may be accommodating.

Each sensor 500 can be provided with a tag 530 which contains its unique sensor identifier 502. (FIG. 5B.) The tag 530 can comprise a printed label on the housing 511 of the sensor 500. Additionally or alternatively, the tag 530 can comprise a scannable barcode on the housing 511 and/or an RFID chip on or with the housing 511.

If the sensor 500 is associated with a particular tire 400 (instead of a rim on which different tires are mounted), the sensor's unique identifier 502 can also serve as the tire's unique identifier 402. The sensor 500 could, for example, be inserted into a tire-integral pocket positioned within the air chamber 410 of a tire.

### Proctors 600

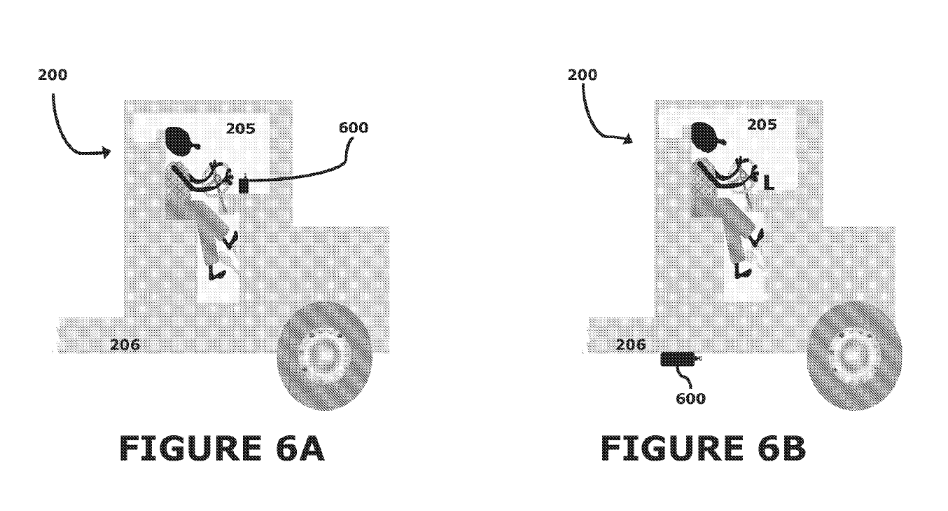

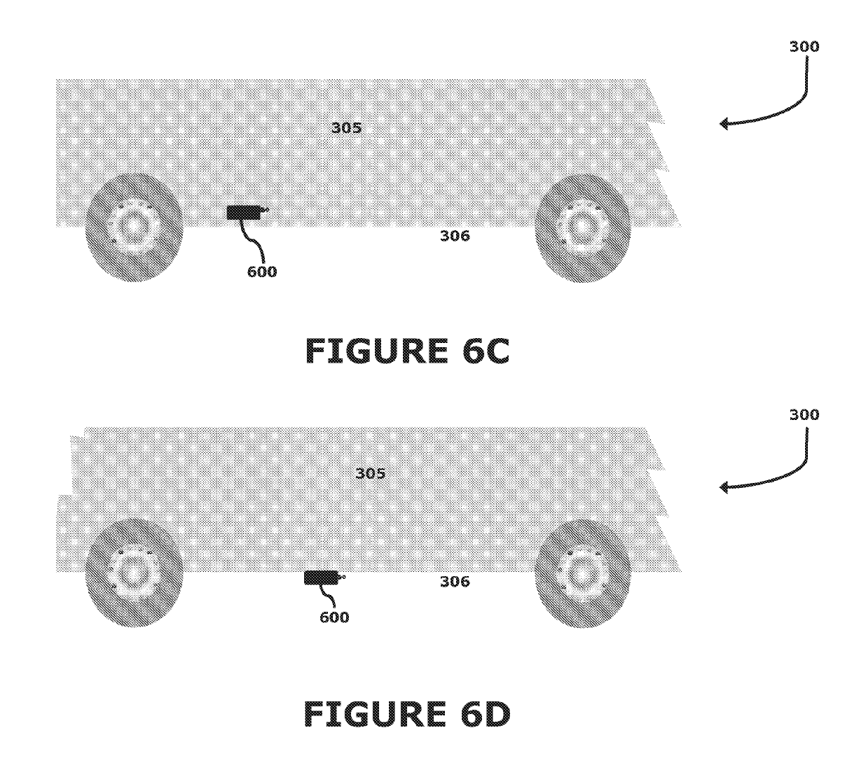

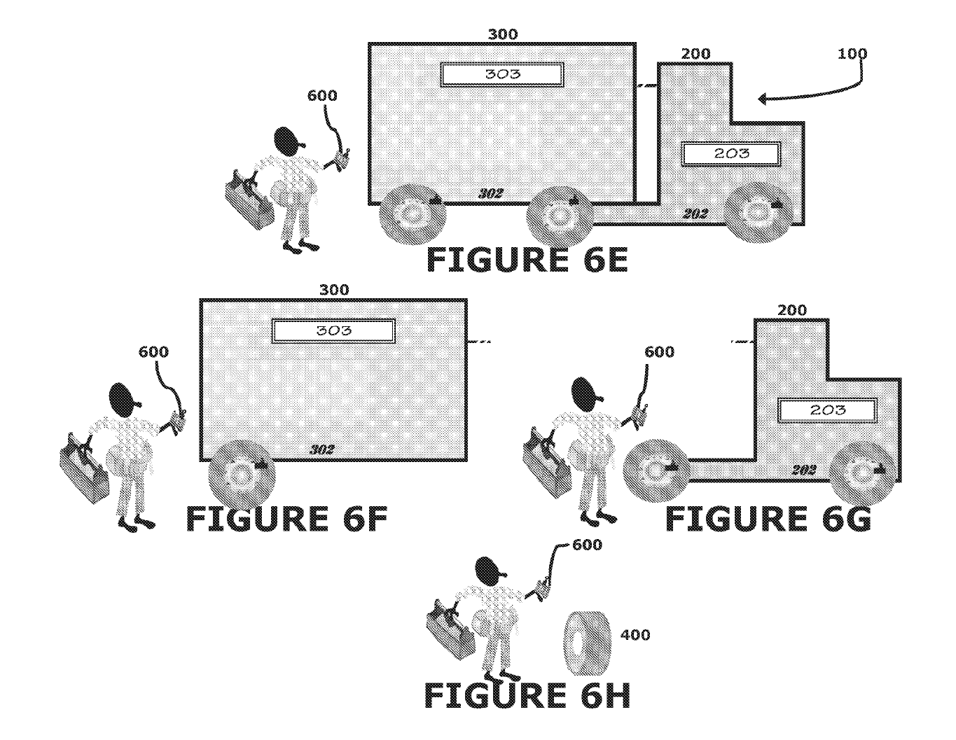

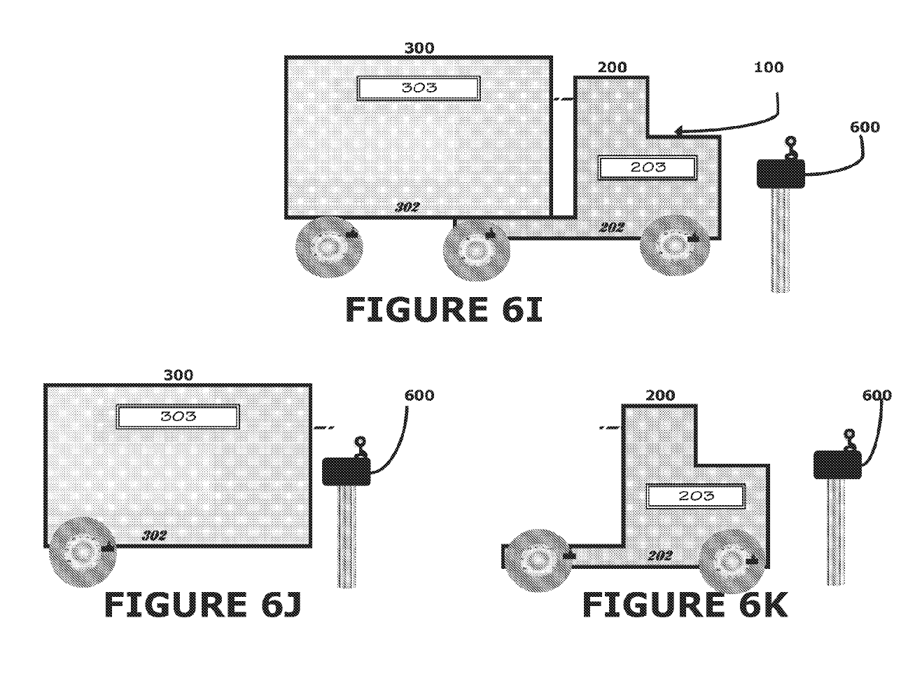

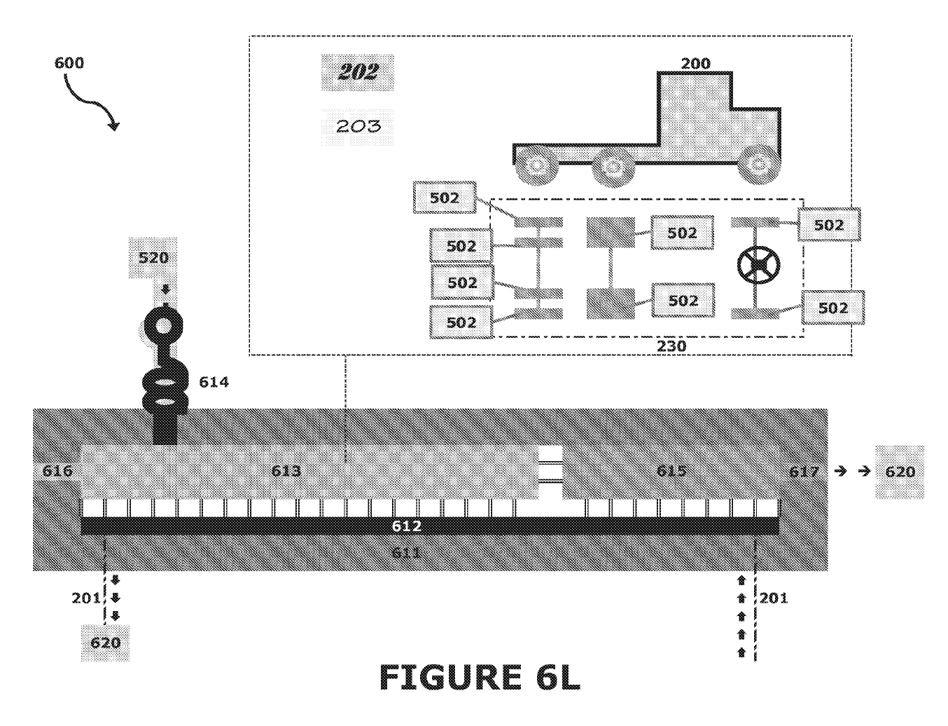

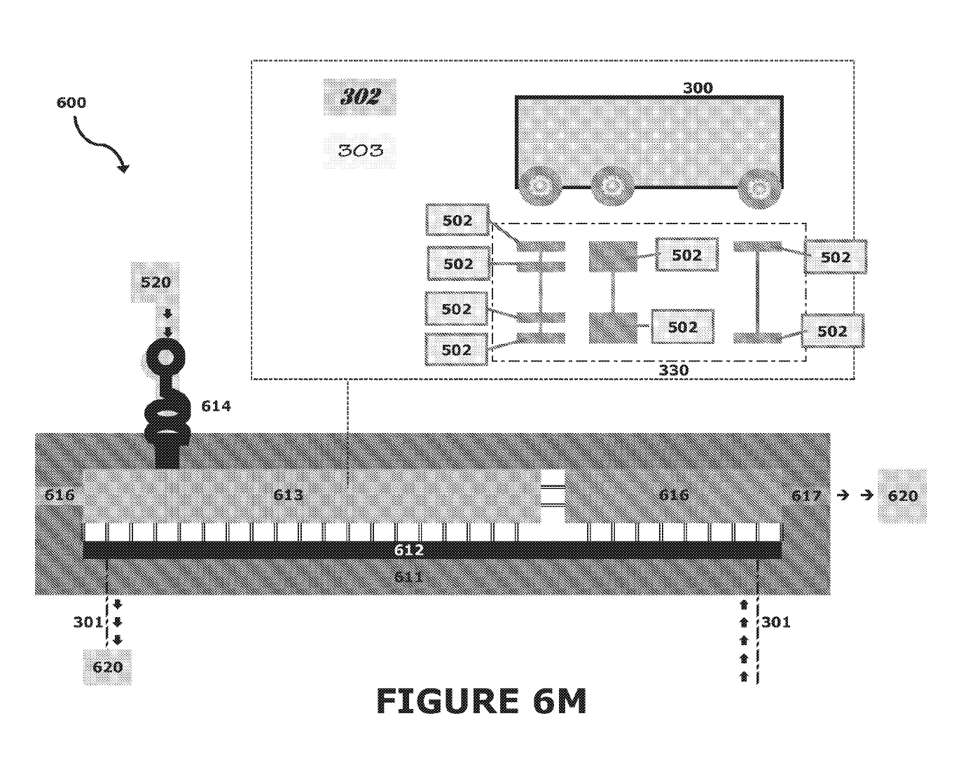

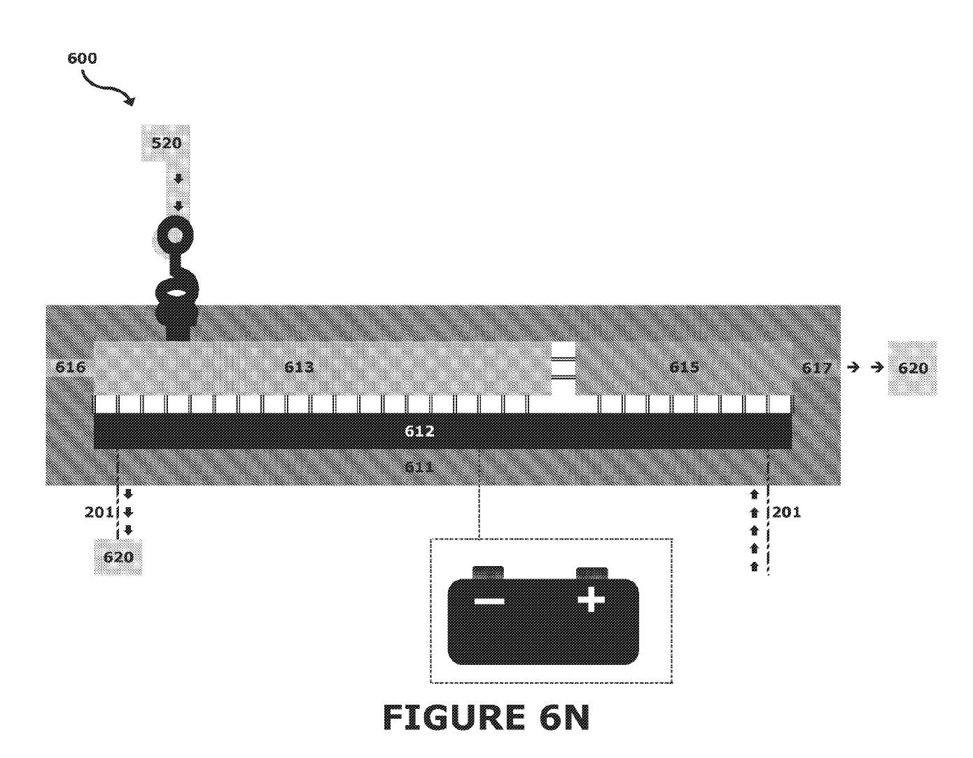

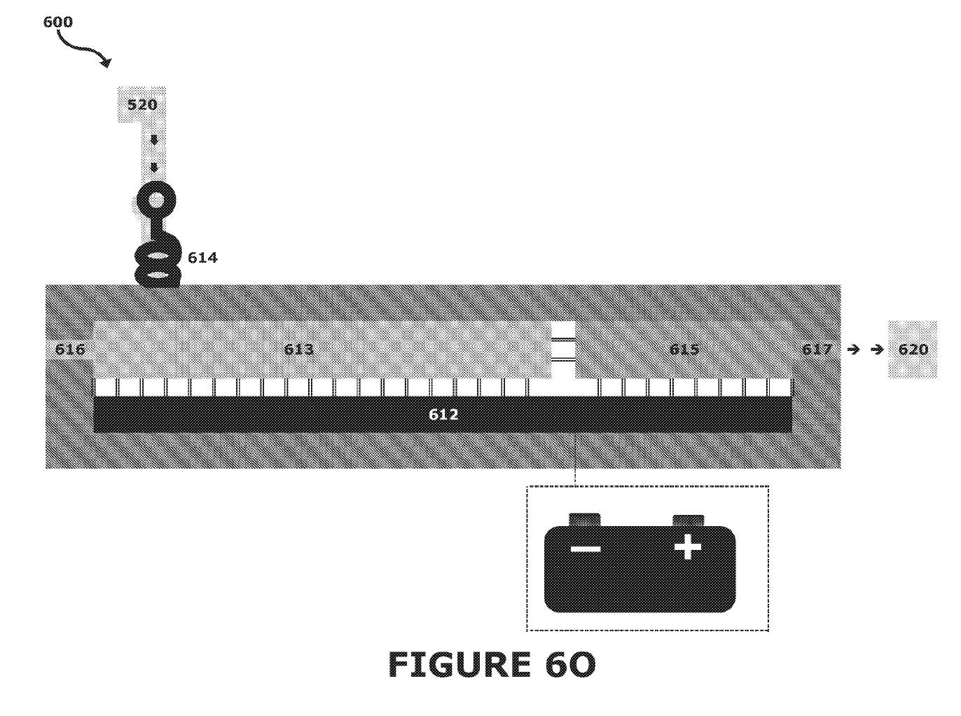

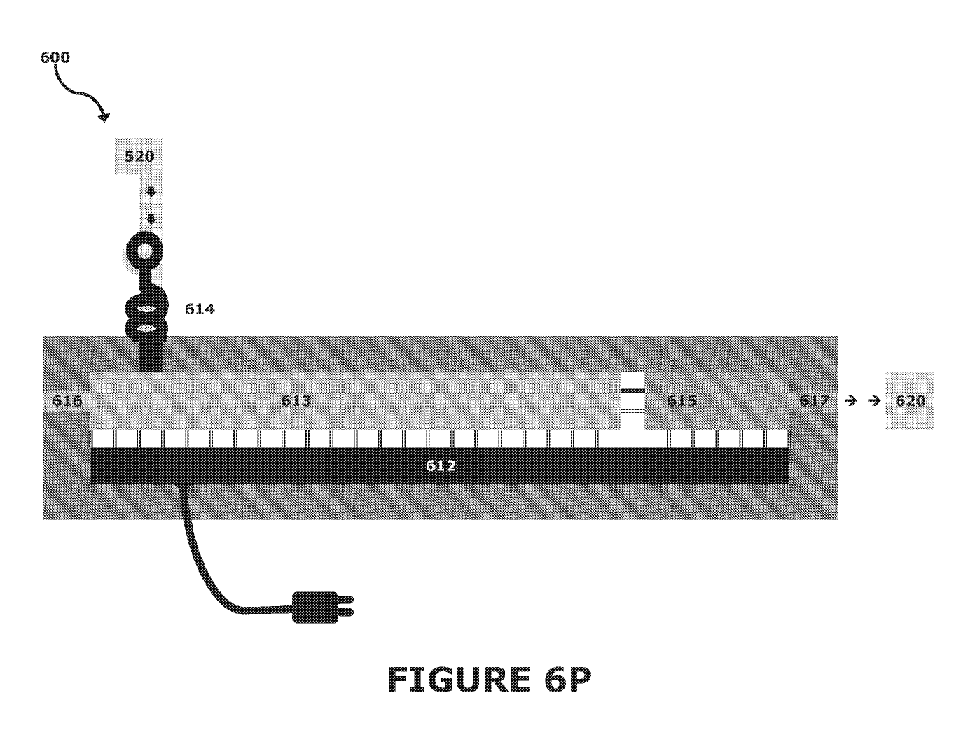

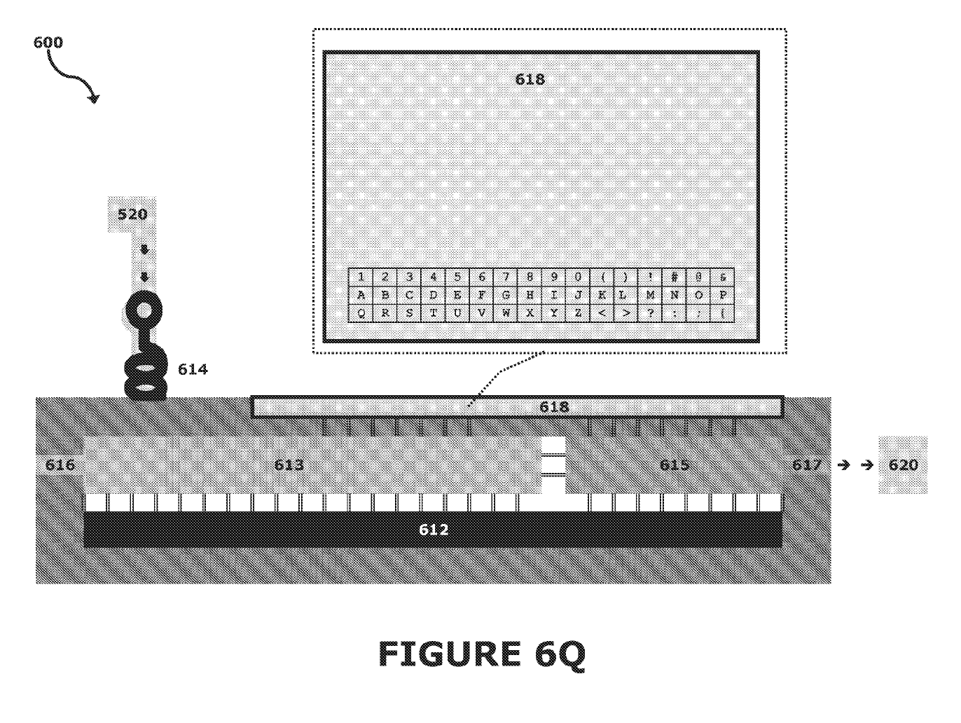

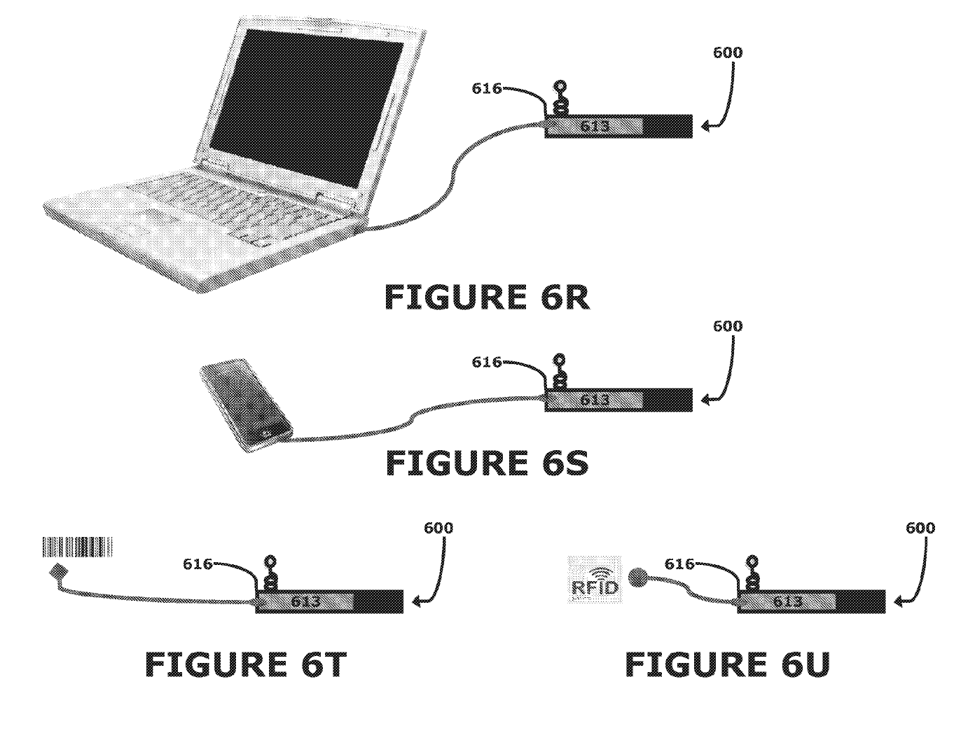

### (FIGS. 6A-6B)

A tire wellness system can include one or more proctors 600 adapted to receive tire-condition data (e.g., the packets 520) from the sensors 500. A proctor's purpose will depend upon its relegated role within a tire wellness system. A proctor 600 can be, for example, a vehicle dedicated proctor, a roaming proctor, or a residence proctor.

A vehicle-dedicated proctor 600 can be installed on tractor 200 so that it receives tire-condition data transmitted by the sensors 500 associated with the tires 400 mounted on its axles 211-212. A tractor-dedicated proctor 600 can be installed in the cab 205 or elsewhere on the vehicle, such as on the bed 206. (FIGS. 6A-6B.).

A vehicle-dedicated proctor 600 can be installed on a trailer 300 so that it receives tire-condition data from the sensors 500 associated with the tires 400 mounted on its axles 311-312. A trailer-dedicated proctor 600 can be installed, for example, in the cargo space 305 or on the bed 306. (FIGS. 6C-6D.).

A vehicle-dedicated proctor 600 can be affixed to a tractor 200 or a trailer 300 so that it is permanently installed thereon. An affixed proctor 600 could be, for example, removed in a matter of minutes with a standard tool (e.g., a screw driver). Other more enduring installations, such as welding, could also be employed. In either or any event, such a permanent installation can discourage the divorce of a proctor 600 from its dedicatee vehicle 200/300.

A vehicle-dedicated proctor 600 can instead be installed with a quick-disconnect engagement allowing it to be selectively removed in matter of seconds without any tools. A quick-disconnect proctor 600 is portable relative to the vehicle 200/300 when it is parked. This portability allows, for example, the proctor 600 to be walked around the vehicle 200/300 for programming purposes. Additionally or alternatively, it can be taken to a comfortable location (e.g., a yard office) for downloading duties.

A roaming proctor 600 can be a portable unit which is conveniently carried when attending to a plurality of vehicles 200/300. A roaming proctor 600 can be used, for example, by yard personnel when checking parked vehicles between trips and/or for inventorying tires 400. A roaming proctor 600 can also or instead be used by independent shops which service vehicles 200/300 while they are on the road. (FIGS. 6E-6H.).

A residence proctor 600 can be a non-portable unit which is occupies a predetermined position when receiving tire-condition data. The proctor's predetermined position can be within a location whereat vehicles 200/300 periodically respite or pass through. A residence proctor 600 can occupy, for example, a preset post in an established vehicle parking area in a fleet yard. (FIGS. 6I-6K.).

A vehicle-dedicated proctor 600, a roaming proctor 600, and/or a residence proctor 600 can comprise a housing 611, a power source 612, a processor 613, an antenna 614, and a memory 615. (FIG. 6L-6P.).

The housing 611 can surround and/or support the proctor parts 612-615 and thus configured to perform these roles. For example, if a vehicle-dedicated proctor 600 is to be installed on a vehicle bed 206/306 (e.g., FIGS. 6B and 6D), the housing 611 can be adapted to withstand exterior mounting and/or road conditions. If a vehicle-dedicated proctor 600 is to be situated in a tractor cab 205, the housing 611 can be acclimated to a dashboard setting. If a proctor 600 is to be portable (e.g., a quick-disconnect proctor or a roaming proctor), the housing 611 can be shaped and sized for convenient carrying in one hand by yard personnel. The housing 611 of a residence proctor 600 can be built to withstand the environment (e.g., weather, wind, water, etc.) and/or the mounting at its predetermined post.

A proctor 600 without an easily recognizable housing 611 is feasible and foreseeable. A vehicle-dedicated proctor 600, for example, could be mingled with other dashboard implements in a tractor's cab. A roaming proctor 600 could be integrated into a laptop, cell phone, or other electronic device carried by yard personnel. A residence proctor 600 could be coalesced into existing structures, such as fences, gates, light poles, concrete curbs, and/or pavement.

The power source 612 can derive power from a connection to the vehicle power lines 201-301 for a vehicle-dedicated proctor 600. As explained in more detail below, vehicle lines 201-301 can also be used transfer data from a vehicle-dedicated proctor 600 to desired destination. Thus the wiring which electrically connects dedicated proctors 600 to vehicle power lines 201-301 would satisfy both power supply and data transmission requirements. (FIGS. 6L-6M.)

If a vehicle-dedicated proctor 600 is intended to be removable from its vehicle (e.g., it has quick-disconnect installation), the power source 612 can derive its power selectively from either a connection a vehicle power lines or an internal battery. (FIG. 6N.)

With a roaming proctor 600, the power source 612 can derive its power from an internal source, such as a battery. The battery could have a reasonable reach between recharging (e.g., at least eight hours, at least ten hours, at least twenty hours, etc.) so as to through a yard shift. The roaming proctor 600 could be built, for example, to allow such recharging without removal of the battery from the housing. (FIG. 6O.)

With a residence proctor 600, the power source 612 can derive its power from existing electrical lines. A residence proctor 600 will often inhabit a site (e.g., a yard) with already-wired electrical gear such as lighting, security, and/or gate control. The placement of a residence proctor 600 in a predetermined position results in wired connections being very practical. (FIG. 6P.)

In certain venues, existing electrical lines may also prove practical for a roaming proctor 600. An enclosed garage, for example, often has power outlets strategically situated around vehicle spaces. Thus, a roaming proctor 600 with a corded electrical connection to house power is feasible and foreseeable.

Regardless of whether a proctor 600 is dedicated, roaming, or residential, the power source 612 can derive power from any suitable supply or supplies. While the examples above involve wired connections or batteries, power derived wirelessly could be expedient and is envisioned. And/or a proctor 600 without a power source 612 per se (e.g., power goes directly to the processor 613 for distribution) is producible and presumed.

A proctor's processor 613 can be programmed by any trustworthy technique. For example, a proctor can include a user-interface panel 618 for direct human input of programming instructions. Such instructions can be submitted by typing, screen-touching, and/or talking. (FIG. 6Q.)

The processor 613 can be additionally or alternatively programmed by connecting it (e.g., via data port 616) to an auxiliary electronic device, such a laptop or a cell phone. For example, programming instructions previously downloaded to the auxiliary device can be electronically transferred to the processor 613. And/or programming instructions being concurrently input into the auxiliary device can be electronically transferred to the processor 613. (FIGS. 6R-6S.)

Other accessories can also or instead be attached to the processor 613 (e.g., via the data port) to aid in the input of programming instructions. For example, a barcode reader or an RFID reader can be connected to the processor 613 and used to read information from tractor tags 230, trailer tags 330, tire tags 430, and/or sensor tags 530. The tag-read information could then be almost immediately and accurately input into the processor 613. (FIGS. 6T-6U.)

If the proctor 600 includes a user interface 618, it can be used to confirm the correctness of information input into the processor 613. For example, the panel's screen could show humanly input instructions so they could be edited for typographical or other unintentional errors. The panel could also translate machine readings into alphabetical characters for human visual verification. (FIG. 6Q.)

The processor 613 is programmed to receive, via the antenna 614, tire-condition data transmitted from the sensors 500. The processor 613 is also programmed to coordinate storing the tire-condition data in the memory 615 and/or coordinate its conveyance to a desired designation.

The processor's coordination can include compiling data packets 620 which include, for example, packet statistical data (e.g., packet length, packet sequence, etc), sensor-identifying data (e.g., unique sensor identifier 502), and tire-condition data (e.g., pressure, temperature, etc.). The data-packet conveyance (to the memory 615 and/or to the desired designation) can occur at a relatively quick frequency (e.g., at least once every three hundred seconds, at least once every two hundred seconds, and/or at least once every one-hundred seconds).

The processor 613 can (but need not) enhance the data packet 620 by including analysis-helpful details such as time stamps, ambient temperatures, global position, and other non-tire-specific information. A proctor-enhanced data packet 620 can also include vehicle-specific information such as vehicle-identifiers 202/302, owner identifiers 203/303, axle-tire configurations 230/330, sensor-tire mapping, and/or tire-pressure thresholds.

A vehicle-dedicated proctor 600 can be programmed to correspond to its vehicle and the sensor-mapping associated therewith. For example, the processor 613 of a tractor-dedicated proctor 600 can be programmed with the tractor's unique vehicle identifier 202, its owner identifier 203, and its tire-axle configuration 230. It can also be programmed to correlate a specific sensor 500 (e.g., by its unique identifier 502) to each 400 in the tractor's axle configuration 230/330. If the tires 400 have unique identifiers 402, they can also be correlated in this manner. (FIG. 6L)

Likewise, the processor 613 of a trailer-dedicated proctor 600 can be programmed with the tractor's identifiers 202-203 and tire-axle configuration 330. The programming can also include a mapping of a specific sensor 500 (e.g., by its unique identifier 502) to each tire 400 in the trailer's axle-configuration 330. If the trailer tires 400 have unique identifiers 402, they can also be programmed into a trailer-dedicated proctor 600. (FIG. 6M.)

The processor 613 of a roaming proctor 600 can be programmed in a similar manner as vehicle-dedicated proctors. It is expected, however, that this programming will occur more frequently as the roaming proctor 600 moves from vehicle-to-vehicle. For example, when a yard employee services the first vehicle 200/300 of his or her shift, vehicle, sensor, and/or tire identifiers are programmed into the roaming proctor 600. Tire-condition data is the collected for this vehicle 200/300 and, if tire-condition problems exist, they are flagged and/or remedied. This process is repeated for each vehicle 200/300 serviced by the yard employee.

The vehicle-by-vehicle programming of a roaming proctor 600 can appear tedious and time-consuming a first glance. However, it is much more enjoyable and efficient than the traditional method involving a clipboard, a pencil, and a manual tire gauge. Moreover, the portability of the roaming proctor 600 makes it especially receptive to accessories such as RFID or barcode readers whereby a vehicle's programming and tire-condition-data collection can be completed in minutes. Also, a roaming proctor 600 is especially amendable to the collection of additional tire-wellness data, such as tread-depth determinations. (FIG. 6N.)

The processor 613 of a residence proctor 600 can be programmed to correspond to contain vehicles identifiers, axle configurations, sensor-mappings, and/or tire identifiers. However, with a residence proctor 600, it may be more effective and efficient to simply collect tire-condition data and then associate this data with vehicles and/or tires on the back end. For example, the data packet 520 discussed above would include a sensor-identification data (e.g., its unique sensor identifier 502) which could be subsequently correlated to a vehicle 200/300 and tire 400. (FIG. 60.)

The processor 613 of a proctor 600 can be additionally programmed to set tire-condition thresholds for the tires 400. For example, a high-pressure threshold and a low-pressure threshold can be set for inflation pressure. The thresholds are preferably settable for each axle 211-212 in a tractor's configuration 230, whereby different axles 211-212 can have different thresholds Likewise, the thresholds are preferably settable for each axle 311-312 in a trailer's configuration 330, whereby different axles 311-312 can have different thresholds.

Threshold programming of a vehicle-dedicated proctor 600 is beneficial when the results can be immediately displayed to truck driver. Threshold programming of a roaming proctor 600 is likewise helpful as it can immediately alert yard personnel as to tire wellness concerns. Threshold violations can be communicated via visual displays (e.g., on a display destination 700, introduced below) and/or by audible alarms. A residence proctor 600 which only collects sensor-sent information (e.g., the sensor's identifier 502 and tire-condition data) would not need to be programmed with thresholds, but so programmed proctor is possible and may be prudent.

With vehicle-dedicated proctors 600, the memory 615 can be relatively large for sufficient data storage between downloads. The memory 615 can be sized, for example, to hold at least fifty hours of tractor-travel time data, at least one hundred hours of tractor-travel time data, and/or at least two hundred hours of tractor-travel time data. The memory 615 can be downloaded wirelessly and/or through a data port 617.

With roaming proctors 600, the memory 615 can be relatively large if all collected data is to be downloaded at the end of shift. However, if a roaming proctor 600 is being used primarily to accelerate and perfect yard inspections, a large memory 615 may not be necessary. For example, if the vehicles 200/300 being inspected have dedicated proctors 600, there would be no reason to duplicate this data storage.

With residence proctors 600, the memory size can correspond to expected download intervals. In many situations, a residence proctor 600 will be adapted to almost immediately deliver tire-condition data to another destination (e.g., a download destination 800 introduced below.). If so, the memory 615 can be sized to provide only a small buffer between delivery intervals.

Regardless of programming procedures and/or memory size, the processor 613 will receive, via the antenna 614, tire-condition data transmitted from the sensors 500. The processor 613 can enhance this tire-condition data with analysis-helpful details (e.g. time stamps, ambient temperatures, etc.). With vehicle-dedicated proctors 600 and roaming proctors 600, this enhanced data can also include pre-programmed information such as the vehicle identifier 202/302 and/or the owner identifier 203/303. With residence proctors 600, the enhanced data could include information its position in the yard.

The processor 613 can then coordinate storing the tire-condition data (and proctor-enhanced data) in the memory 615 and/or coordinate its conveyance to a desired designation. This coordination can include compiling data packets 620 which include, for example, packet statistical data (e.g., packet length, packet sequence, etc.), vehicle identifying data (e.g., the tractor's unique identifier 502 and its owner identifier 503), tire-condition data (e.g., pressure, temperature, etc.), and other relevant data. The data-packet conveyance (to the memory 615 and/or to the desired designation) can occur at a relatively quick frequency (e.g., at least once every three hundred seconds, at least once every two hundred seconds, and/or at least once every one-hundred seconds).

### Display Destinations 700

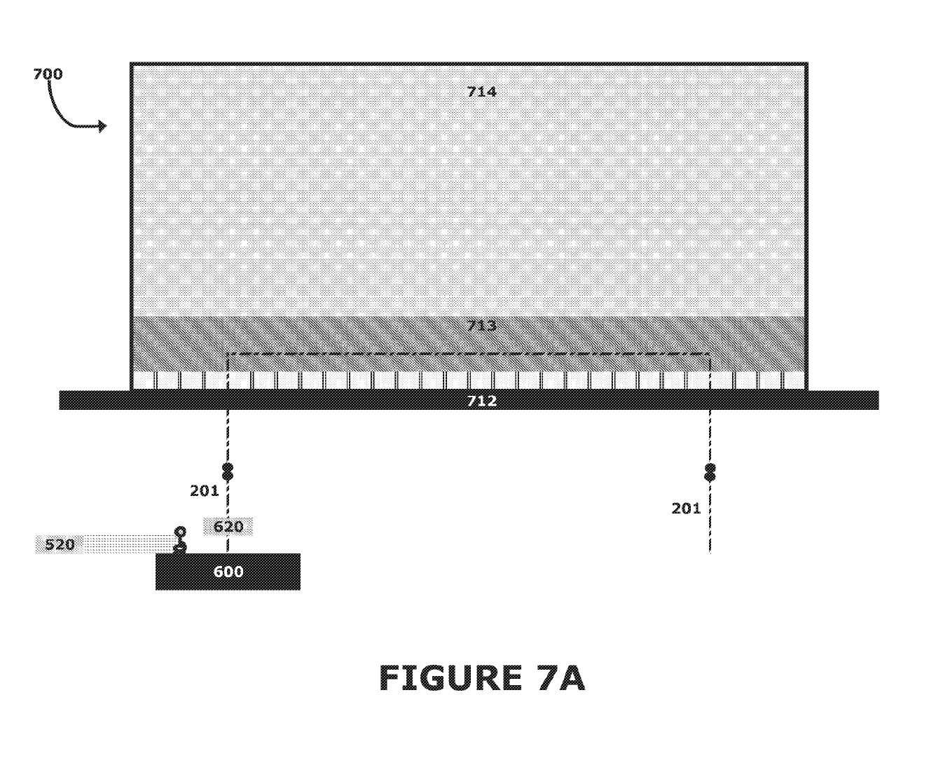

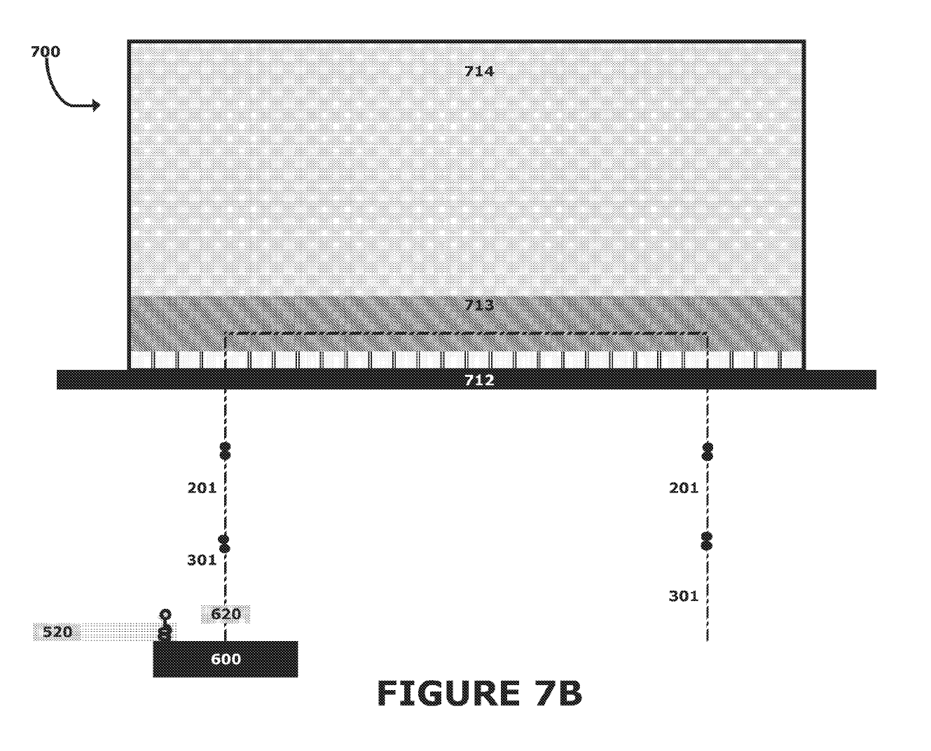

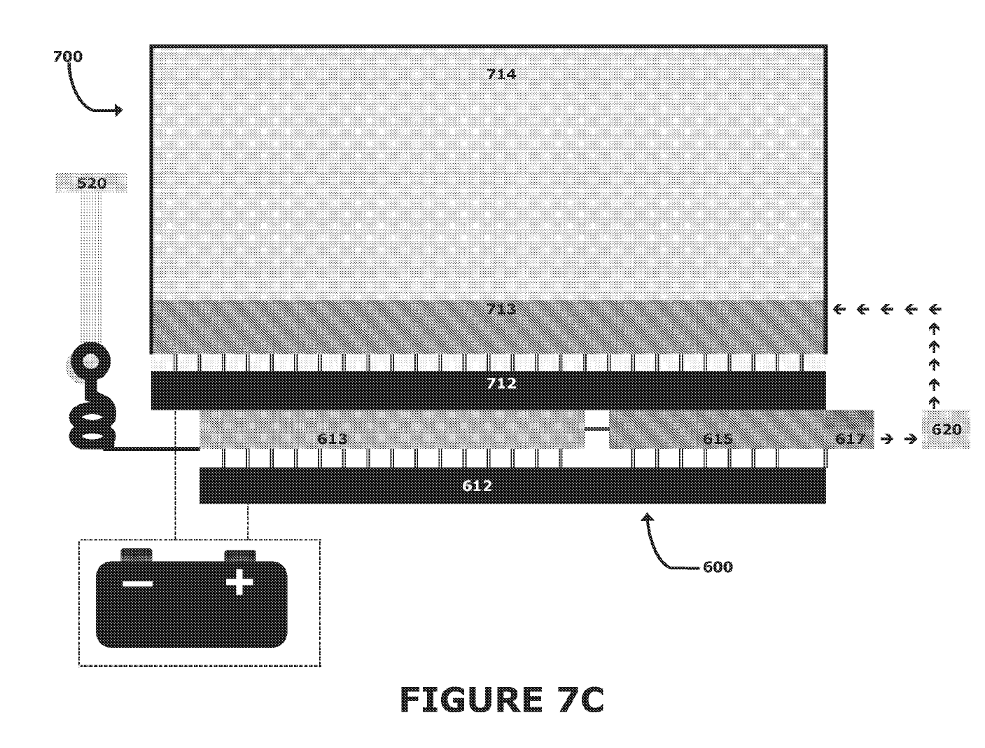

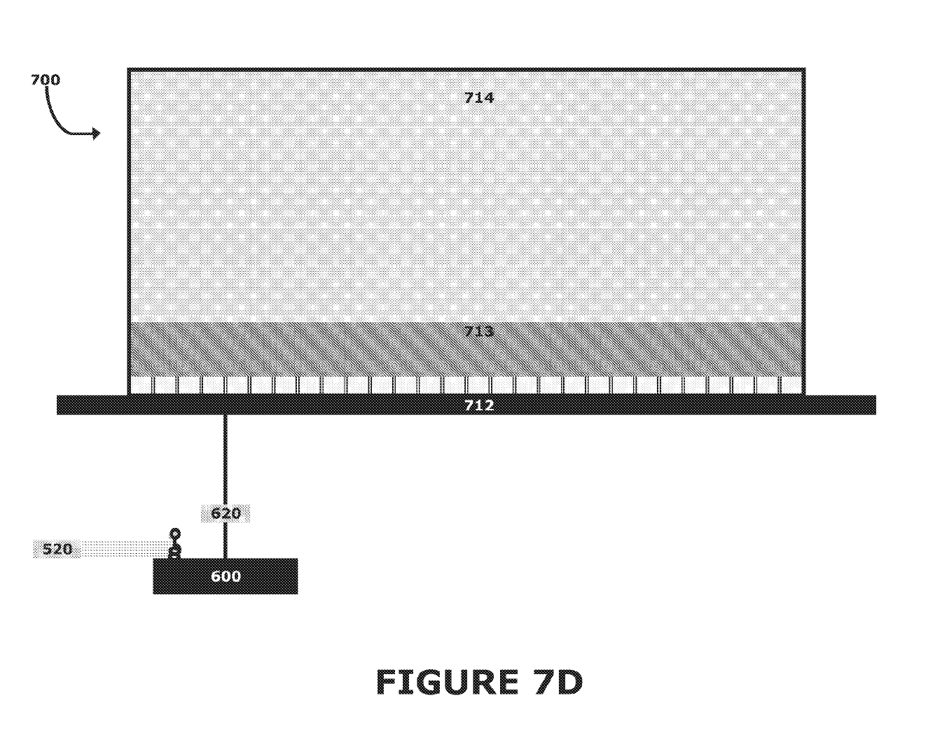

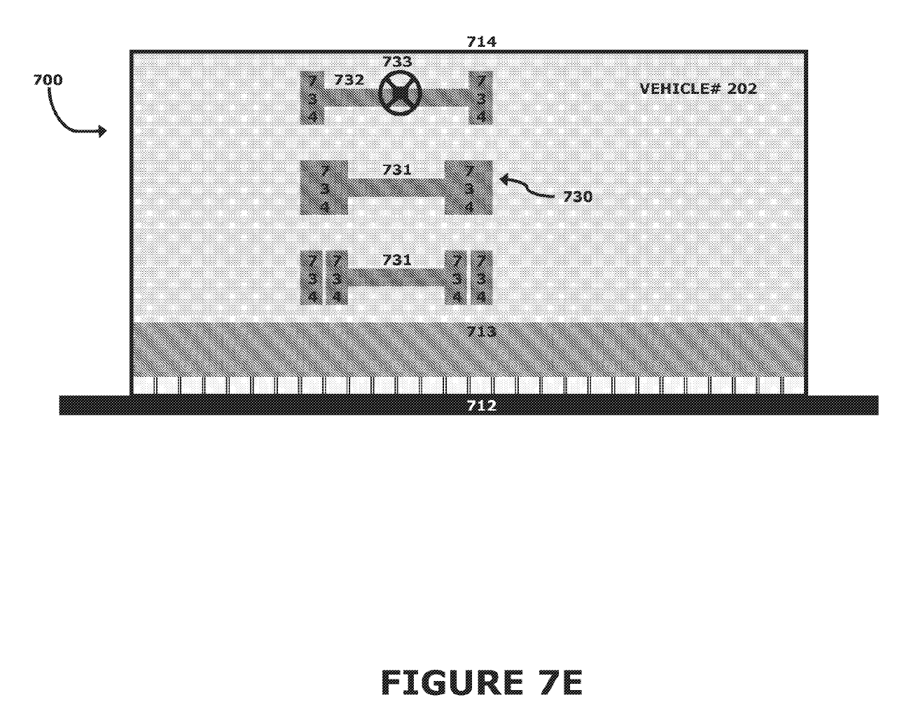

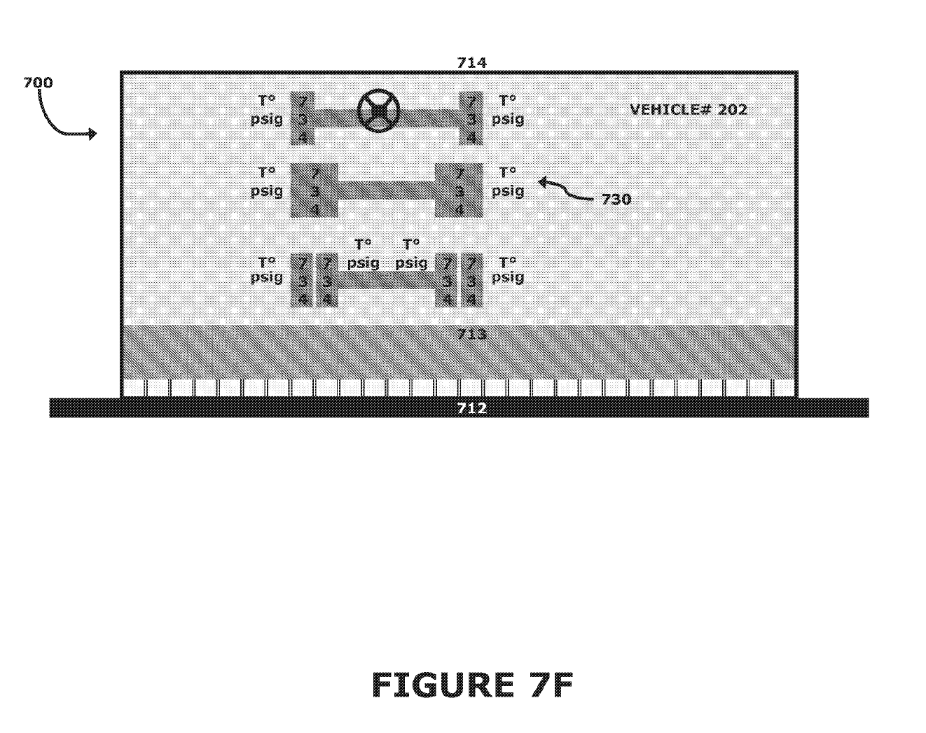

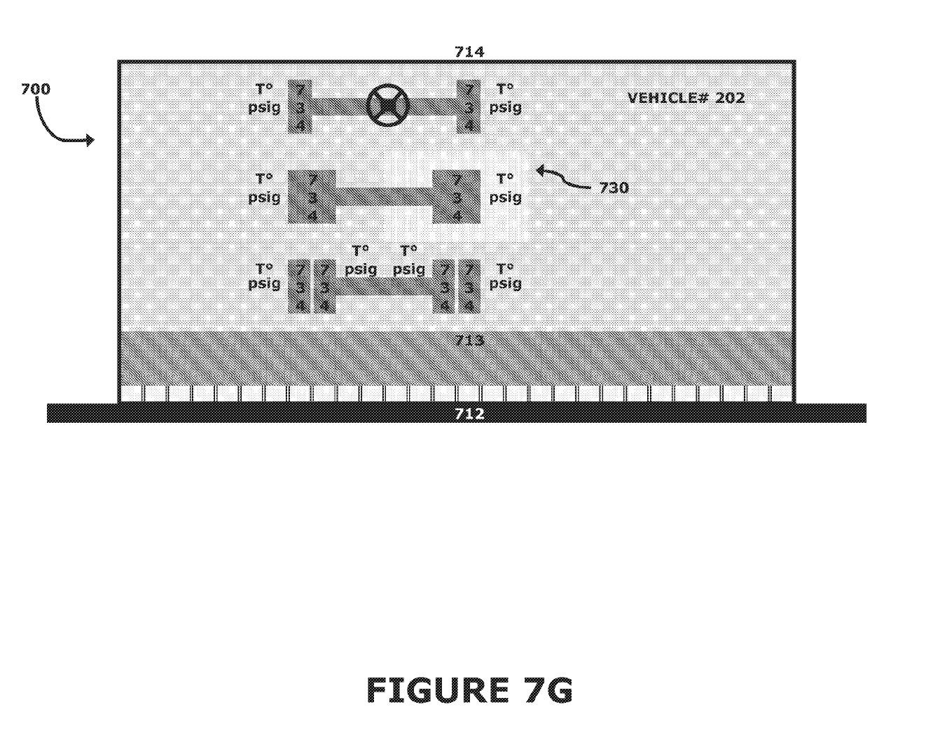

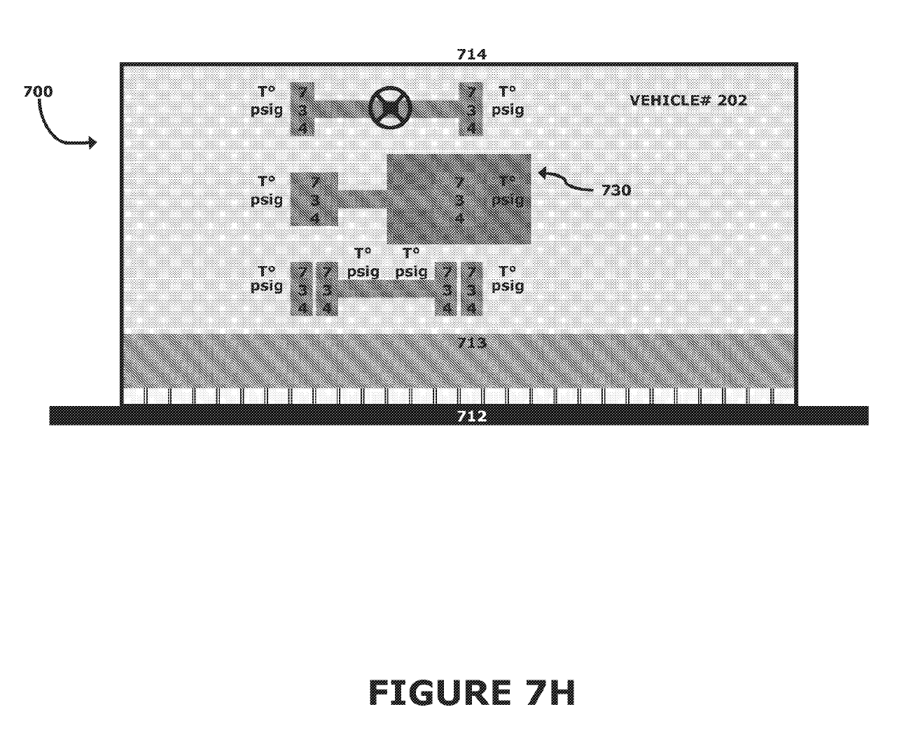

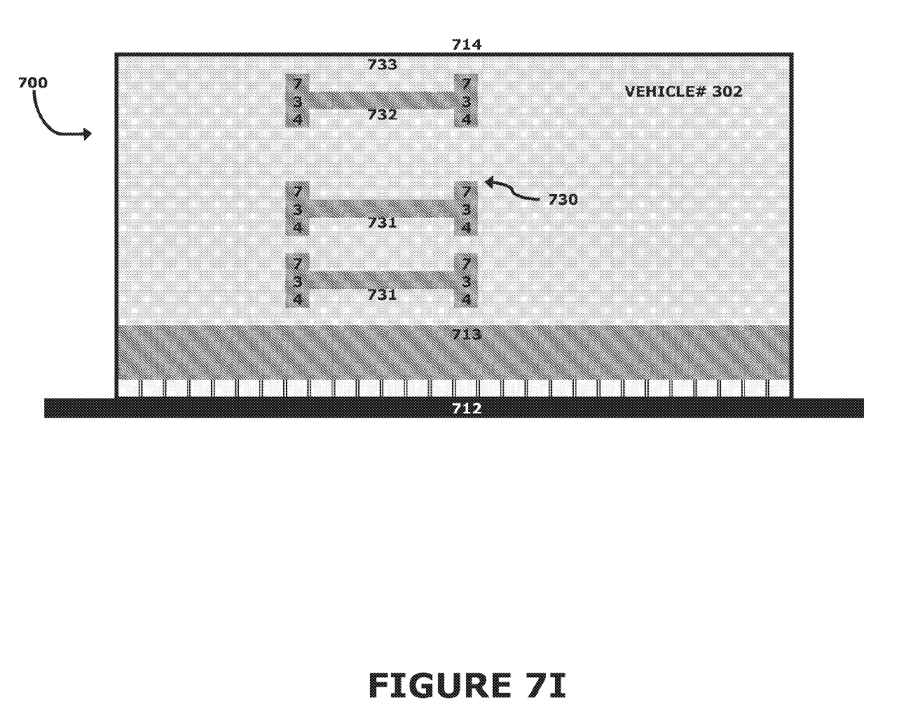

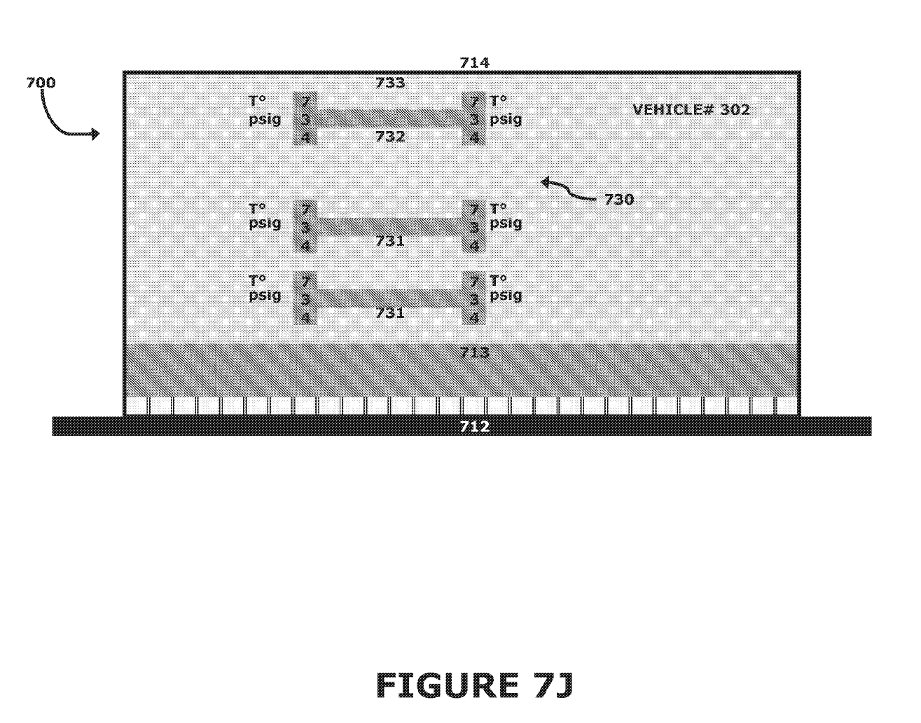

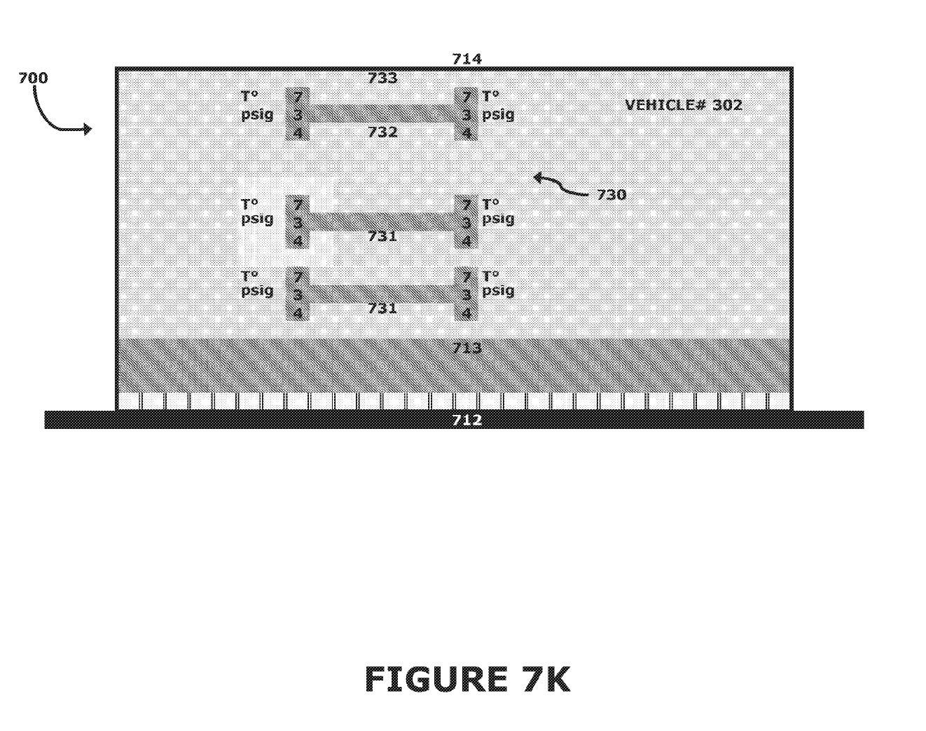

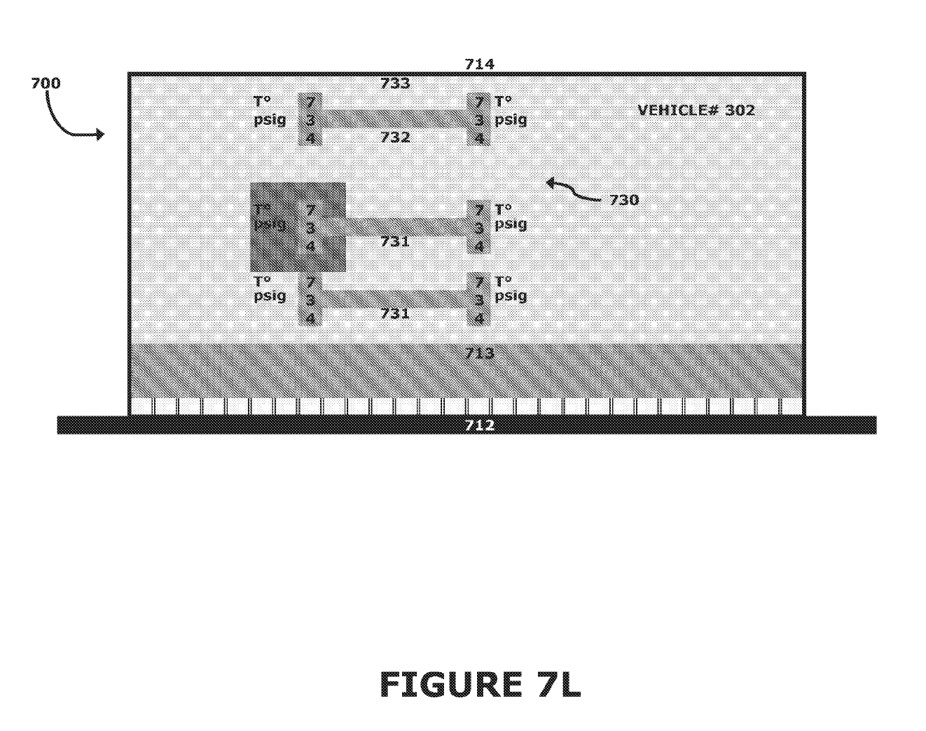

### (FIGS. 7A-7L)

A tire wellness system can include a display destination 700 for allowing immediate (e.g. almost realtime) access to tire-condition data. With a vehicle-dedicated proctor 600, a desired display destination 700 could be elsewhere on a truck 100. With a roaming proctor 600, a desired display destination 700 could be on the proctor itself so as to add to its portability. With a residence dedicated proctor 600, a desired display destination could be remote from the vehicle 200/300 and the proctor 600, such as in the yard office. (FIGS. 7A-7D.)

The display destination 700 includes a power source 712, a processor 713, and a display screen 714. The power source 712 can vary depending upon display demographics. If the destination 700 is on a truck 100, the source 712 can derive power from the vehicle lines 202-203. If the display destination 700 is incorporated into a proctor 600, the source 712 can derive its power from the same place as the proctor's power source 612. And if the display destination 700 is at a remote location relative to the vehicle 200/300 and not part of a proctor 600, the source 712 can derive its power from that available at the remote location.

The display processor 713 can determine the relevant vehicle's tire-axle configuration 230/330 and sensor-tire mapping, define tire-pressure thresholds, and receive tire-condition data from the proctor 600 associated within this vehicle.

The processor's determination of tire-axle configuration 230/330, sensor-tire mapping and thresholds can be tailored to the parameters of the proctor 600 delivering the tire-condition data. If configuration, mapping, and thresholds are already programmed into the proctor's processor 623, they can be directly delivered therefrom to the display processor 713. For example, for a display destination 700 inside a truck 100, the power lines 201-301 can be used to deliver each vehicle's tire-axle configuration and sensor-tire mapping to the processor 713.

Specifically, upon connection of the tractor power line 201 (or any appropriate time or times thereafter), the tractor proctor 600 can convey the tractor's tire-axle configuration 220 and corresponding sensor-tire mapping to the processor 713. Upon connection of a trailer power line 301 to the tractor power line 201 (or any appropriate time or times thereafter), the trailer proctor 600 conveys the trailer's tire-axle configuration 320 to the display's processor 713, along with any relevant sensor-tire mapping and thresholds. This conveyance is repeated for each additional trailer 301 in the truck 100.

If the display destination 700 is incorporated into a proctor 600, the relevant vehicle's tire-axle configuration 230/330 and corresponding sensor-tire mapping can be conveyed directly by the proctor's processor 613. In fact, with such incorporation, the proctor processor 613 and the display processor 713 could be merged. With a roaming proctor 600, for example, tire-axle configuration and sensor tire-mapping are often programmed just prior to a vehicle's inspection.

If the display destination 700 is remote from the relevant vehicle and the delivering proctor 600 tire-axle configuration 230/330 can be delivered in any suitable manner. But with a residence proctor 600, for example, this information might not even be known by the processor 613. If so, the processor 713 can be programmed to determine the tire-axle configuration 230/330 and sensor-mapping based on unique vehicle identifiers 202/302. In fact, with appropriate programming, a display processor 713 could use only a sensor's unique identifier 502 (conveyed in the sensor data packet 520) to determine a vehicle's unique identifier, its tire-axle configuration, and its tire-sensor mapping.

Tire thresholds can be delivered by a proctor 600 to the display processor 713 in much the same manner as tire-axle configuration and sensor-tire mapping. Alternatively, the processor 713 can be programmed to define thresholds based on other identifiers. And a display processor 713 which assigns thresholds without reference to proctor-delivered information is an option.

The display processor 713 will always receive tire-condition data from a proctor 600, as this data can be derived from predetermined information. A processor 713 which directly receives tire-condition data from a sensor 500 would be considered a merged version of a both a proctor 600 and a display destination 700. The roaming proctor-display shown in FIG. 7C is an example of such merging. Another example would be a proctor-display in a tractor cab 205 A vehicle display destination 700 can be mounted in the tractor cab 205 at a location conveniently viewable by the driver during truck operation (e.g., the dashboard). While trailer-dedicated proctors 600 and/or residence proctors 600 could also be merged with a display destination 700, there might be no reason for this if they are not visible to drivers and/or yard personnel.

The processor 713 can draws a diagram 730 of the conveyed tire-axle configuration 230 for display on the screen 720. Tire-condition data can then charted on this diagram and, if thresholds are violated this can be noticeably illustrated. Thus a brief visual perusal of the diagram 730 can completely communicate overall tire conditions.

Specifically, for example, with a tractor 200, the diagram 730 can include axle icons 731-732, a steering wheel icon 733 (to signify a steering axle), and tire icons 734. The tire icons 734 are situated in a pattern corresponding to that of the tractor's tires 400, with double-width tires being distinguishable by, for example, “wider” tire icons. When tire-condition data is received for a tire 400, it is listed near the relevant tire icon 734 on the diagram 730.

If thresholds are crossed, the processor 713 pictorially illustrates this on the diagram 722 to show exactly which tire 400 is the culprit. A threshold crossing can be illustrated, for example, by the corresponding tire icon 734 turning a noticeable color (e.g., yellow), blinking, and/or becoming noticeably larger. Audio alerts can also be used to draw attention to the display screen 714. (FIGS. 7E-7H.)

A similar diagram 730 can be drawn for trailer 300 (except without a steering wheel icon) for a visual charting of its tire conditions. The display destination 700 also displays the vehicle's unique identifier 302 so as to distinguish vehicles in a multi-trailer truck. (FIGS. 7I-7L.)

When a display destination 700 is mounted in a truck 100, the tractor and trailer proctors 600 can continuously send, at frequency approximately the same as sensor transmission, data packets 620 through the power line 201 to the display 700. Tire data is displayed on the screen 720 and threshold-crossing is brought to the attention of the driver.

With roaming proctor 600, the incorporated display destination 700 could immediately alert yard personnel as to which tire 400 on a being-inspected vehicle needs attention. Also, supervisors could use the roaming proctor-display to confirm the adequacy of inspections and repairs. A similar expediency could be enjoyed by independent repair shops.

With a residence proctor 600, the display destination 700 could swiftly scrutinize a yard full of vehicles to detect those with tire issues. And for each detected vehicle, the display destination 700 could also pinpoint the troubled tire. If a residence proctor 600 is programmed to transmit its location in a yard, vehicle locations could be prioritized.

### Download Destinations 800

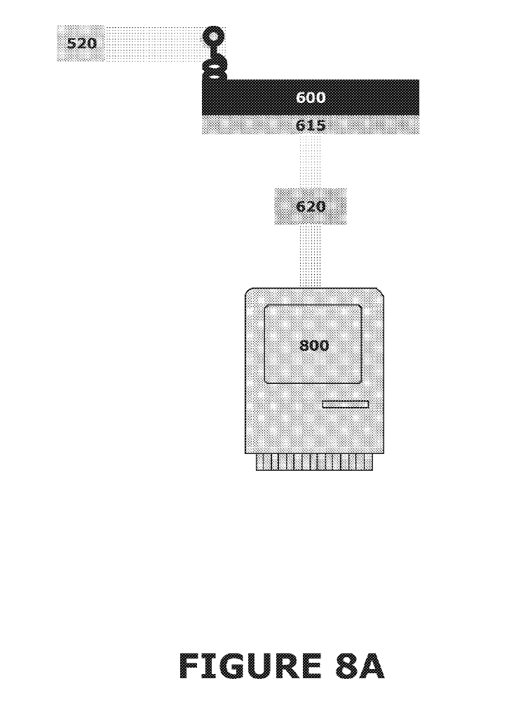

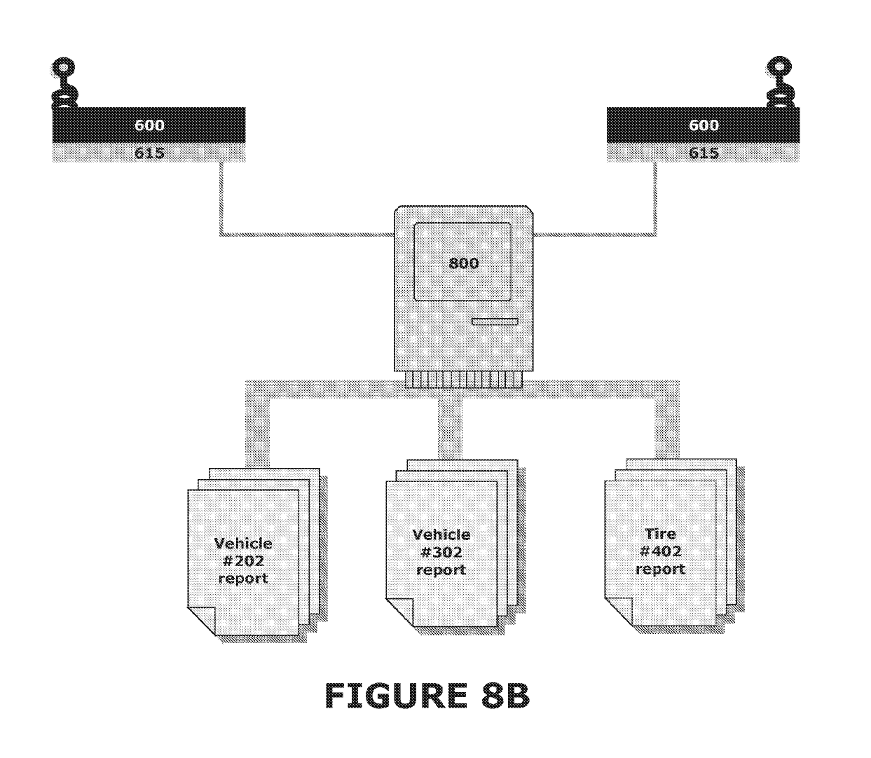

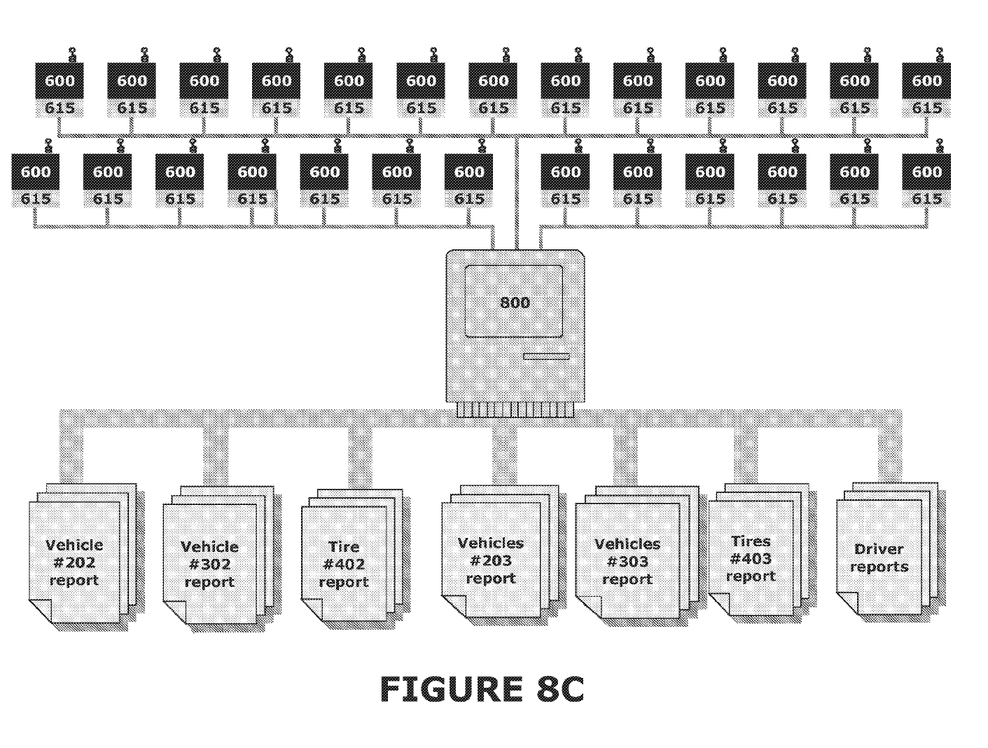

### (FIGS. 8A-8C)

As was indicated above the proctors 600 each have a memory 615. The data stored in these memories 615 can be periodically downloaded to a download destination 800 (e.g., a server). Alternatively, data can be immediately sent to a download designation 800 in realtime or almost realtime. With realtime downloads, the data can bypass the memory 65 or dwell only instantaneously therein.

The download destination 800 can be remote from the vehicles 200-300, the tires 400, the sensors 500, and/or the proctors 600. A download destination 800 for a proctor 600 can (but need not be) at different location than its display destination 700. (FIG. 8A.)

Downloading can be accomplished wirelessly or through data ports. For example, data can be transferred via cellular lines. The download can occur in realtime (or near realtime) or subsequent to the data being collected. In either or any event, this collected data can provide a wealth of knowledge for historically and analytical reporting. Specifically, for example, reports can be run on tractor performance, trailer performance, and even individual tire performance. (FIG. 8B.)

When data is downloaded from a multitude of vehicles, even more meaningful reports may be compiled. In addition to individual vehicle and tire performance reports, fleet (e.g., vehicles having the same owner identifiers 203 and 303) and tire batch (e.g., tires having the same production identifier 403) reports can be assembled. And when truck drivers are constantly assigned to different vehicles (whereby their performance is not reflected in vehicle performance), driver reports can be created to promote incentive objectives. (FIG. 8C.)

### Fleets 900

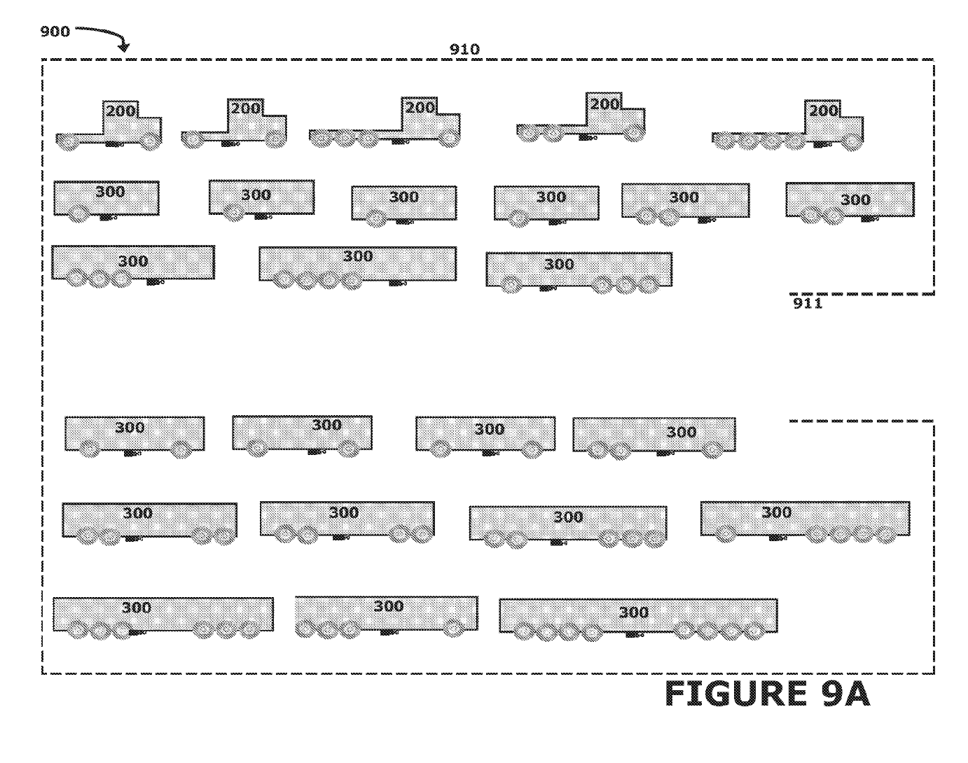

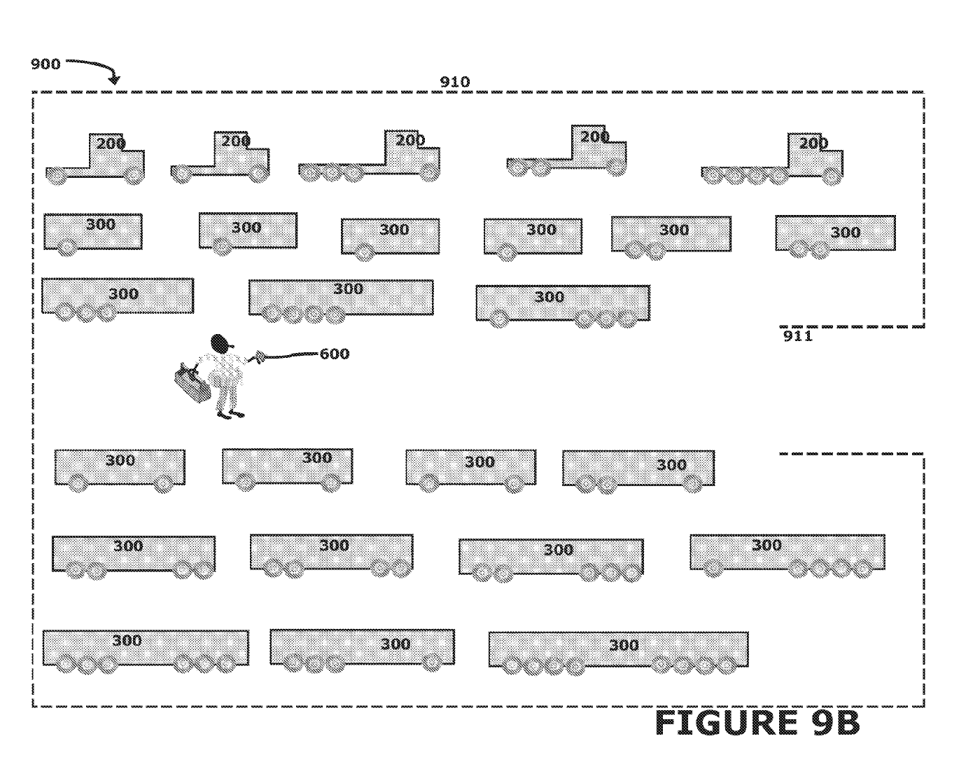

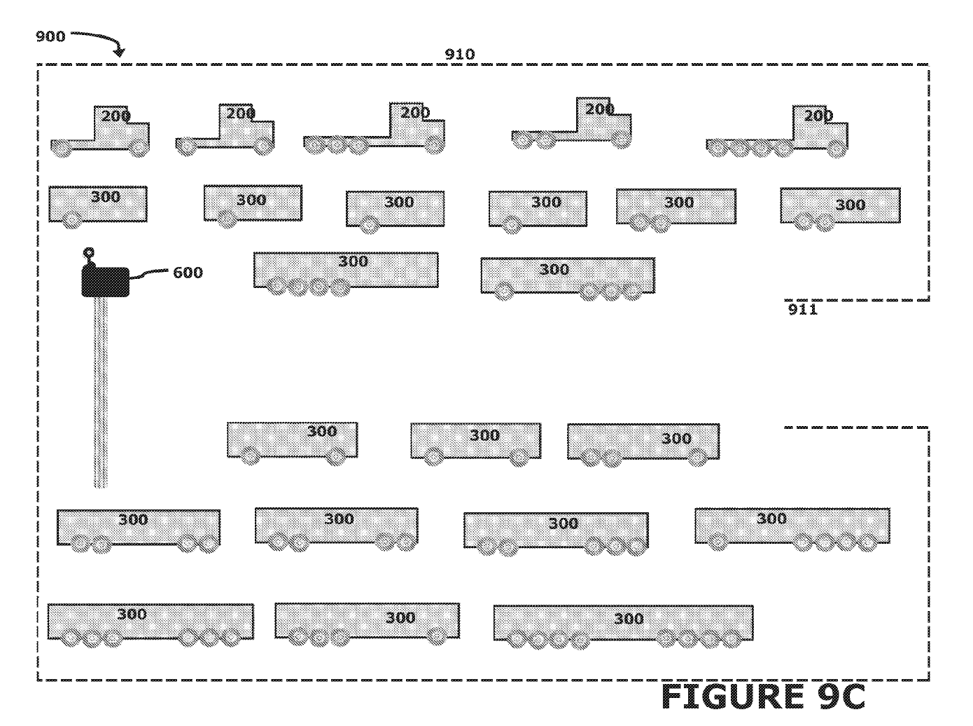

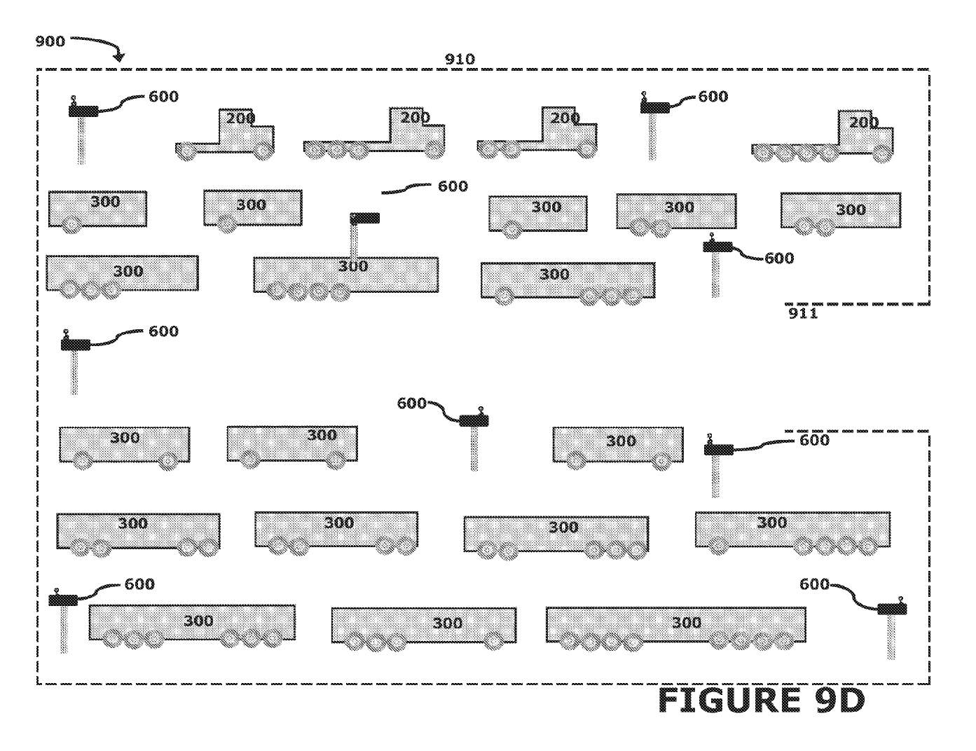

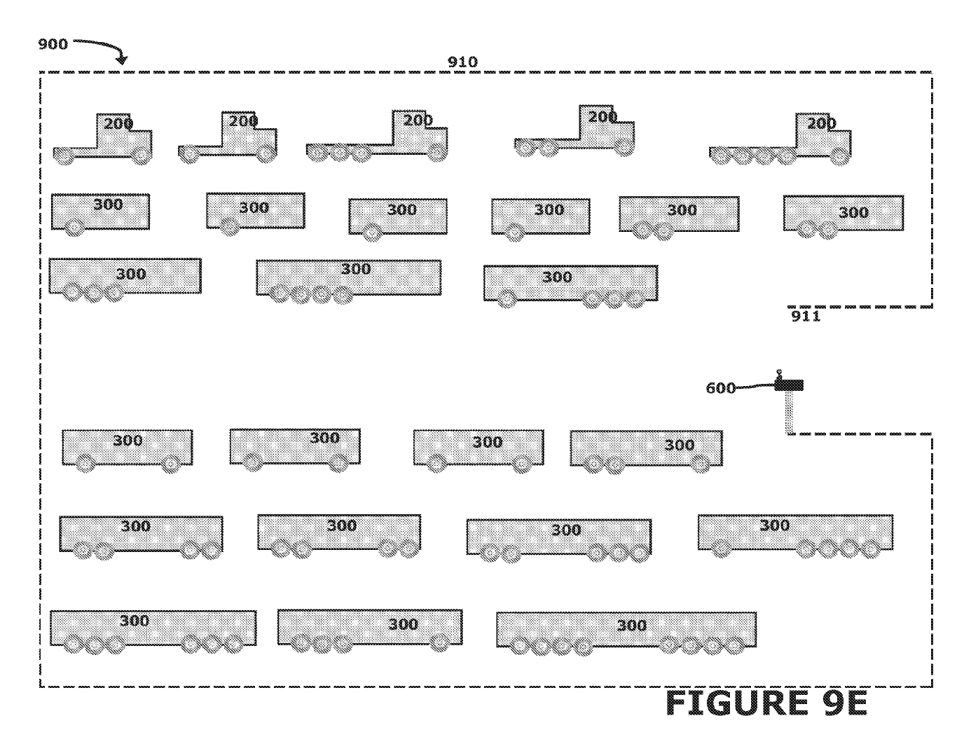

### (FIGS. 9A-9E)

A fleet 900 can comprise a plurality of tractors 200 and a plurality of trailers 300 which are interchangeably hitched to each other. The tires 400 on the vehicles 200/300 include sensors 500. When not on truck runs, the vehicles 200/300 can be parked at a yard 910, which has an entrance/exit gate 911.

In a fleet 900, each vehicle 200/300 can include a dedicated proctor 600 so that regardless of hitching, tire-condition data is preserved for later downloading and analysis. And if each tractor 200 includes a display destination 700, it will be automatically updated upon hitching one or more trailers 300 thereto. (FIG. 9A.)

Yard personnel can be employed to inspect the tires 400 in the fleet 900 when vehicles 200/300 are parked in the yard 910. Yard personnel can be provided with a roaming proctor 600 to carry during such inspections. The tractors 200 and/or the trailers 300 may or may not include vehicle-dedicated proctors 600. (FIG. 9B.)

A residence proctor 600 can be mounted in the yard 910 to receive tire-condition data from the parked vehicles 600/700. The residence proctor 600 delivers this data to a display destination 700 which displays each vehicle (and which particular tire on this vehicle) needs attention. The proctor 600 can also deliver this data to a download destination for the generation of reports. (FIG. 9C.)

Instead of a single residence proctor 600 covering the entire yard 910, an array of residence proctors 600 can be positioned throughout the yard. This array arrangement reduces the sensor-transmitting distance needed to collect tire-condition data throughout the yard 910. The proctors 600 can deliver data to a display destination 700 and/or download destination 800. With appropriately programmed proctors 600 and/or global-positioning data from one or more program players (e.g., vehicles 200/300, tires 400, sensor 500, and/or proctors 600) the location of a vehicle-of-interest in the yard 910 could be pinpointed. (FIG. 9D.)

A residence proctor 600 could additionally or instead be mounted at the entrance/exit gate 911 into the yard 910. The proctor 600 could receive tire-condition data from each vehicle 300/400 which passes through the gate 911. Depending upon the transmission frequency of the sensors 500, a truck 100 could drive through the gate 911 at a normal speed or be required to pause for a few seconds. (FIG. 9E.)

After passing through the gate 911, the truck 100 could park in a usual manner. Tire-condition data from the proctor 600 can be delivered to a display destination 700 and/or a download destination 800. Immediate or subsequent analysis of the tire-condition data can be depended upon to discover any tire-wellness concerns.

A residence proctor 600 could include an alarm to indicate if a truck 100 contains a tractor 200 or trailer 300 with a tire-pressure problem. If the alarm-equipped proctor 60 is one of an array covering a large yard, a visual alarm (e.g., a blinking light) could help navigate yard personnel to its location. If the alarm-equipped proctor 60 is at a gate 911, fleet protocol could require that, upon an alarm being triggered, the truck 100 is parked in a certain yard area for further inspection.

### Closing

Although the trucks 100, the tractors 200, the trailers 300, the tires 400, the sensors 500, the proctors 600, the display destinations 700, the download destinations 800, the fleets 900, and associated methods, systems, steps, and/or reports have been set forth in certain ways, they should not be considered exhaustive nor quintessential. Analogous alternations, meaningful modifications, reasonable revisions, virtuous variations, and/or advantageous adaptations will occur to others skilled in the art upon a reading and understanding of this disclosure.

1. A truck comprising;
a tractor having an axle arrangement which includes at least one rear axle and a steering axle;
a trailer hitched to the tractor, the trailer having an axle arrangement which includes at least one rear axle and which may include no front axle or more than one front axle;
at least one tire mounted on each end of each of the tractor's axles in a tire-axle configuration and at least one tire mounted on each end of each of the trailer's axles in a tire-axle configuration;
a sensor associated with each tire, each sensor acquiring tire-condition data about its respective tire and transmitting this tire-condition data;
a tractor proctor mounted to the tractor which receives the tire-condition data transmitted from the sensors associated with the tires mounted on the tractor axles; and
a trailer proctor mounted to the trailer which receives the tire-condition data transmitted from the sensors associated with the tires mounted on the trailer axle(s).

2. A truck as set forth in claim idle preceding claim, wherein the tractor comprises a tractor power line, wherein the trailer comprises a trailer power line electrically connected to the tractor power line to form a truck power line.

3. A truck as set forth in claim 1, comprising a second trailer hitched to the first trailer hitched to the tractor; wherein:
the second trailer has an axle arrangement which includes at least one rear axle and which may include no front axle or more than one front axle;
at least one tire is mounted on each end of each trailer axle of the second trailer;
a sensor is associated with each tire mounted on each trailer axle the second trailer, each sensor acquiring tire-condition data about its respective tire and transmitting this tire-condition data; and
a second trailer proctor mounted to the second trailer which receives the tire-condition data transmitted from the sensors associated with the tires mounted on the trailer axle(s) of the second trailer.

4. A truck as set forth in claim 3, wherein the tractor comprises a tractor power line, wherein the first trailer comprises a power line electrically connected to the tractor power line, and wherein the second trailer has a trailer power line electrically connected to the trailer power line of the first trailer to form a truck power line.

5. A truck as set forth in claim 3, comprising a third trailer hitched to the second trailer; wherein;
the third trailer has an axle arrangement which includes at least one rear axle and which may include no front axle or more than one front axle;
at least one tire is mounted on each end of each trailer axle of the third trailer;
a sensor s associated with each tire mounted on each trailer axle of the third trailer, each sensor acquiring tire-condition data about its respective tire and transmitting this tire-condition data; and
a third trailer proctor mounted to the third trailer which receives the tire-condition data transmitted from the sensors associated with the tires mounted on the trailer axle(s) of the third trailer.

6. A truck as set forth in claim 5, wherein the tractor comprises a tractor power line, wherein the first trailer comprises a power line electrically connected to the tractor power line, wherein the second trailer comprises a power line electrically connected to the trailer power line of the first trailer, and wherein the third trailer has a power line electrically connected to the power line of the second trailer to form a truck power line.

7. A truck as set forth in claim 1, wherein each proctor has a processor programmed to correspond to its vehicle's tire-axle configuration and programmed with a mapping of the sensors to this tire-axle configuration.

8-31. (canceled)

32. A vehicle comprising:
an axle arrangement including at least one axle;
at least one tire mounted on each end of each axle to provide the vehicle with a tire-axle configuration;
a sensor associated with each tire, each sensor acquiring tire-condition information about its respective tire and transmitting this information;
a proctor mounted to the vehicle which receives the tire-condition information transmitted from the sensors;
wherein the proctor has a processor programmable to correspond to the tire-axle configuration and to map the sensors to this tire-axle configuration.

33. A vehicle as set forth in claim 32, wherein the proctor has memory in which the tire-condition data received by the proctor is stored until it is downloaded.

34. A vehicle as set forth in claim 33, wherein the download is accomplished wirelessly.

35. A vehicle as set forth in claim 34, wherein the download is accomplished via cellular lines.

36. A vehicle as set forth in claim 34, wherein the tire-condition data from each proctors' memory is downloaded to a server.

37. A vehicle as set forth in claim 33 wherein the tire-condition data from each proctors' memory is downloaded to a portable proctor and then downloaded to a server.

38. A vehicle as set forth in claim 33, wherein a/the server produces reports from the downloaded tire-condition data.

39. A vehicle as set forth in claim 38, wherein the server is located remote from the vehicle.

40-57. (canceled)

58. A fleet comprising a plurality of vehicles parked in a yard and proctor mounted in or near the yard; wherein:
each vehicle has an axle arrangement including at least one axle and at least one tire is mounted on each end of each axle;
wherein a sensor is associated with each tire which acquires tire-condition information about its respective tire and transmits this information;
wherein the proctor receives the tire-condition information transmitted from the sensors; and
wherein the proctor delivers the tire-condition information to a display destination and/or a download destination.

59. A fleet as set forth in claim 58, wherein the proctor delivers the tire-condition data to a display destination which displays each vehicle which needs attention.

60. A fleet as set forth in claim 58, wherein the display destination displays which particular tire has wellness issue on each vehicle which needs attention.

61. A fleet as set forth in claim 58, wherein the proctor delivers the tire-condition data to a download destination for the generation of reports.

62. A fleet as set forth in claim 59, wherein an array of proctors are positioned through the yard.

63-73. (canceled)
